(19) United States
(12) Patent Application Publication
(10) Pub. No.: US 2026/0289677 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/561,606

(22) Filed: Mar. 10, 2026

(30) Foreign Application Priority Data
Mar. 19, 2025 (JP) 2025-044942

(51) Int. Cl. G06Q 40/06; G06N 5/022

(52) U.S. Cl. CPC G06Q 40/0631; G06N 5/022

(57) ABSTRACT

A system includes a processor that is configured to; generate a prompt that instructs a generative AI model to perform evaluation of a plurality of investment instruments in order to compare the plurality of investment instruments and propose an optimal investment instrument to a user; store past investors'experience and knowledge in a database and cause an artificial intelligence to generate an investment strategy with reference to the database; and recognize an emotional state of the user in real time and adjust the investment strategy based on the emotional state by using an emotion engine.

### CROSS-REFERENCE TO RELATED APPLICATION

This application is based on and claims priority under 35 USC 119 from Japanese Patent Application No. 2025-044942 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional investment advisory systems suffer from multiple limitations. First, such systems typically rely on static rules or fixed scoring models to compare a plurality of investment instruments, and therefore cannot flexibly adapt to complex and rapidly changing market conditions or to diverse user profiles. Second, known systems do not effectively utilize accumulated experience and knowledge of past investors in a structured manner, and consequently fail to generate sophisticated, context-aware investment strategies that reflect historically proven patterns and expert judgment. Third, conventional systems generally treat the user as a purely rational decision maker and do not recognize or respond to the user's emotional state in real time, which can lead to recommendations that are theoretically optimal but practically unsuitable when the user is anxious, overconfident, or otherwise emotionally biased. As a result, existing technologies do not sufficiently provide individualized and dynamic investment support that simultaneously considers objective financial data, expert-like knowledge, and the user's current emotional condition. There is therefore a need for a system that can (i) employ a generative AI model to evaluate and compare multiple investment instruments, (ii) systematically leverage a database of past investors'experience and knowledge to generate investment strategies, and (iii) recognize and incorporate the user's emotional state in real time, thereby providing more appropriate and adaptive investment proposals.

### SUMMARY

In order to solve the above-described problems, an aspect of the present invention provides a system comprising a processor, wherein the processor is configured to generate a prompt that instructs a generative AI model to perform evaluation of a plurality of investment instruments in order to compare the plurality of investment instruments and propose an optimal investment instrument to a user. The processor is further configured to store past investors'experience and knowledge in a database and to cause an artificial intelligence to generate an investment strategy with reference to the database, thereby enabling the system to reflect historically derived patterns and expert-like insights in the generated strategy. In addition, the processor is configured to recognize an emotional state of the user in real time and to adjust the investment strategy based on the emotional state by using an emotion engine, so that the proposed strategy is dynamically tailored to the user's current psychological condition. In certain embodiments, the processor is configured to include, as the plurality of investment instruments, at least one investment instrument selected from the group consisting of an individual-type defined contribution pension plan, a small-amount investment tax-exempt scheme, an installment-type investment scheme, and a junior investment scheme. In further embodiments, the processor is configured to generate a prompt that instructs the generative AI model to propose the optimal investment instrument based on information including an investment objective of the user and a risk tolerance of the user. By virtue of these configurations, the system is capable of providing highly personalized, context-aware, and emotionally adaptive investment proposals that overcome the limitations of conventional investment advisory technologies.

The term “processor” refers to a hardware or virtual computing element, such as a central processing unit (CPU), graphics processing unit (GPU), microcontroller, or distributed processing resource, that executes instructions to perform data processing, control logic, and communication necessary to implement the functions of the system.

The term “generative AI model” refers to a machine learning model, such as a large language model or other neural network-based generative model, that is trained on data to generate outputs including text, numerical scores, or structured data, in response to input prompts.

The term “prompt” refers to a structured input, including text, parameters, or control tokens, that is provided to the generative AI model in order to specify a task, define evaluation criteria, or request generation of an output related to investment instrument evaluation or strategy proposal.

The term “investment instrument” refers to a financial product or scheme in which a user can allocate capital with the expectation of returns, and includes, for example, pension plans, tax-advantaged accounts, installment-type investment schemes, and junior investment schemes.

The term “plurality of investment instruments” refers to two or more different investment instruments that are concurrently considered, evaluated, or compared by the system.

The term “optimal investment instrument” refers to an investment instrument that is selected or recommended by the system as most suitable for a user, based on evaluation criteria including, for example, the user's investment objective, risk tolerance, and financial situation.

The term “past investors'experience and knowledge” refers to information derived from historical investment activities, decisions, performance records, expert analyses, and related annotations, which has been collected, organized, and structured for use by the system.

The term “database” refers to an organized collection of data, stored on a non-transitory storage medium and managed by a database management system, in which past investors'experience and knowledge are recorded so that they can be accessed, searched, and referenced by the artificial intelligence.

The term “artificial intelligence” refers to a computational system, model, or module that performs tasks such as pattern recognition, prediction, decision-making, or strategy generation, including but not limited to machine learning models, rule-based engines, or hybrid systems.

The term “investment strategy” refers to a set of rules, policies, allocations, or recommendations regarding how a user should invest in one or more investment instruments over time, taking into account factors such as risk, return, time horizon, and market conditions.

The term “emotional state of the user” refers to a psychological condition of the user at a given time, including, for example, states such as anxiety, fear, calmness, optimism, or overconfidence, which can influence the user's investment decisions.

The term “recognize an emotional state of the user in real time” refers to detecting, estimating, or classifying the user's emotional state during an ongoing interaction or within a short time frame, using input signals such as user responses, behavior logs, biometric data, or interaction patterns.

The term “emotion engine” refers to a hardware or software module that analyzes data indicative of the user's emotional state, generates an assessment of that emotional state, and provides control signals or parameters to adjust the investment strategy based on the assessed emotional state.

The term “individual-type defined contribution pension plan” refers to a retirement investment scheme in which contributions are made to an individual account for the benefit of a specific user, with investment returns depending on the performance of selected assets, and where the user generally bears the investment risk.

The term “small-amount investment tax-exempt scheme” refers to a tax-advantaged investment framework in which investment gains or dividends on qualifying investments up to a specified contribution limit are exempt from certain taxes.

The term “installment-type investment scheme” refers to an investment arrangement in which the user periodically contributes fixed or variable amounts into one or more investment instruments over a continuous or predefined period.

The term “junior investment scheme” refers to an investment arrangement established for the benefit of a minor or child, typically with tax or legal characteristics tailored to junior account holders, and used for purposes such as education funding or long-term asset formation.

The term “investment objective of the user” refers to the primary purpose or goal that the user intends to achieve through investment, including, for example, retirement funding, education expenses, wealth accumulation, or capital preservation.

The term “risk tolerance of the user” refers to the degree of variability in investment returns and potential loss that the user is willing and able to accept, taking into account psychological preferences, financial capacity, and investment horizon.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

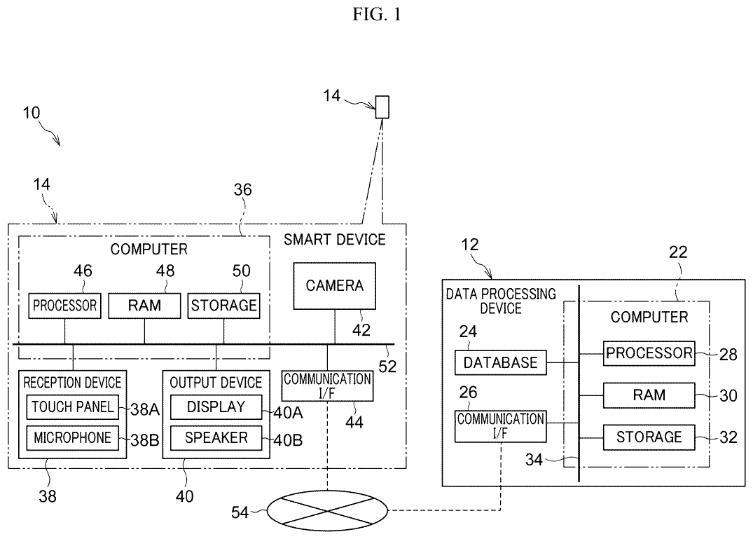

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

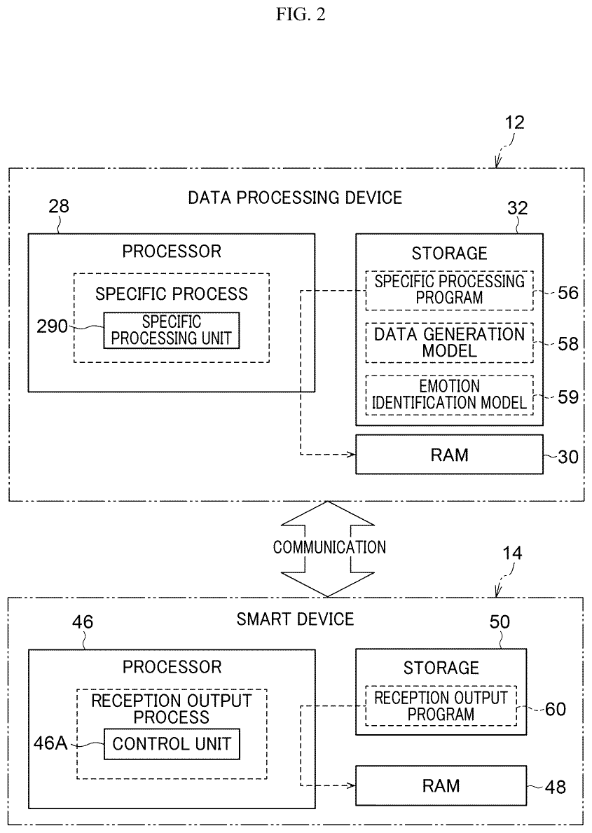

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented investment advisory systems typically either rely on static rule-based engines or apply machine learning models in isolation from the user-facing natural-language interaction. In such systems, user attributes and investment objectives are often handled as loosely structured input, and the resulting advice is generated using pre-defined templates or generic text, without tightly coupling underlying quantitative analysis to the actual natural-language output. As a result, these systems suffer from several technical problems.

First, existing systems do not systematically normalize and structure user attribute information and investment objective information into a machine-readable user profile that directly drives downstream computational processing. Age, risk tolerance, and investment horizon are frequently processed as free text or simple fields, which hampers efficient computation, reuse, and updating of the profile within the system. This leads to redundant data processing, increased latency, and difficulty in maintaining consistency across multiple recommendation cycles.

Second, existing systems generally do not integrate quantitative analytics pipelines and generative AI models in a unified prompt-generation architecture. Historical market data and product attributes may be analyzed by separate analytical modules, and natural-language responses may be generated by independent text generators or user-interface layers. However, there is no technical mechanism to construct, in a standardized and automated way, a composite prompt that embeds structured context information, including quantitative indicators derived from statistical or machine learning models, together with a natural-language inquiry from the user. This disconnect leads to suboptimal utilization of computational resources, because the generative AI model cannot fully leverage precomputed numerical results, and often recomputes or ignores information already available in the system.

Third, conventional systems do not provide an efficient feedback loop in which execution of investments by the user automatically updates the underlying user profile and suitability indicators at the data structure and model level. In many implementations, user actions are logged only as transactional records, and are not propagated back into the internal representations used for subsequent prompt generation and model-based ranking. This limits the system's ability to adapt over time to changing user behavior or refined risk preferences, and forces repeated manual input or separate re-onboarding workflows.

Fourth, current architectures often handle the interaction between a user terminal and a server in a fragmented manner, where profile construction, product ranking, and text generation are spread across multiple heterogeneous services that are loosely coupled. This can lead to inefficient data transfer, duplicated computations, and increased processing latency, especially when large-scale market data and complex models are used. Moreover, without a coherent design for the processor's configuration, it is difficult to guarantee deterministic and auditable processing steps from input acquisition through quantitative analysis to natural-language generation.

Therefore, there is a need for a computer-implemented technique that improves the way a processor acquires, structures, and updates user profiles; computes risk and return indicators for multiple financial products; and generates and supplies to a generative AI model a prompt sentence that systematically integrates quantitative context and user natural-language inquiries. Such a technique should establish a technically improved server-side architecture that coordinates data normalization, analytical computation, prompt construction, model invocation, and feedback-based updating, thereby reducing redundant processing, improving consistency and traceability of recommendations, and enabling efficient, adaptive investment guidance at scale.

The specific processing by the specific processing unit 290 of the data processing device 12 in Example 1 is realized by the following means.

The present invention provides a server comprising a processor configured to acquire user attribute information and investment objective information from a user terminal, normalize the acquired information, construct and store a structured user profile including at least an age category, an investment objective category, a numerical risk tolerance indicator, and a numerical investment period indicator, calculate, based on the user profile and historical data including attribute information of a plurality of financial products and market data, for each of the financial products, a return indicator and a risk indicator by using a statistical analysis program or a machine learning program, generate a suitability indicator associated with the user's risk tolerance and the investment period, generate a prompt sentence by integrating context information including the user profile, the plurality of financial products ranked according to the suitability indicator, and the return indicator and the risk indicator for each of the financial products with a natural-language inquiry sentence acquired from the user, input the prompt sentence to a generative AI model so as to cause the generative AI model to generate proposal content and an explanatory text indicating financial products suitable for the user, format the proposal content and the explanatory text into output data including financial product list information and investment policy information, transmit the output data to the user terminal for display, and update, in response to an investment execution instruction based on the proposal content acquired from the user terminal, the user profile and the suitability indicator so as to reflect the updated user profile and suitability indicator in subsequent generation of the prompt sentence and calculation of the suitability indicator. This enables a technically improved investment advisory system in which user-specific structured profiles, quantitatively derived indicators, and generative natural-language output are tightly integrated at the processor level, thereby reducing redundant computations, improving responsiveness and consistency of recommendations, and providing an adaptive feedback loop that automatically refines internal representations and subsequent advice based on user actions.

The term “user terminal” refers to an information processing apparatus, such as a client device or communication device, that is operated by a user and is configured to transmit user input to, and receive output data from, a server via a communication network.

The term “user attribute information” refers to information indicating characteristics of a user, including at least age, risk tolerance, and other personal or financial parameters that are used to construct a user profile.

The term “investment objective information” refers to information indicating a user's investment-related goals, including at least a target purpose, a target period, and possibly a target amount, which are used to determine appropriate investment strategies.

The term “user profile” refers to a structured data representation of a user, constructed by normalizing and encoding user attribute information and investment objective information into machine-readable parameters, including at least an age category, an investment objective category, a numerical risk tolerance indicator, and a numerical investment period indicator.

The term “age category” refers to a categorical data field representing a range or bucket of ages, obtained by classifying a numerical age into a predefined age group for use in computational processing.

The term “investment objective category” refers to a categorical data field that classifies a user's investment objective information into one of a plurality of predefined objective types, such as retirement, education funding, or asset growth.

The term “numerical risk tolerance indicator” refers to a numerical value or score that quantifies a user's tolerance for investment risk on a predetermined scale so that it can be processed by statistical analysis programs or machine learning programs.

The term “numerical investment period indicator” refers to a numerical value indicating a duration of an investment horizon, expressed for example in years or months, and used as an input parameter in quantitative analysis.

The term “historical data” refers to stored data sets including at least past market information, such as prices or index values over time, and attribute information of financial products, such as fees, asset class, and past performance.

The term “financial product” refers to an investment-related product or investment means that can be selected by a user, including at least a tax-advantaged account, a contributory pension scheme, an installment-type investment scheme, and a minor-oriented investment scheme.

The term “attribute information of a plurality of financial products” refers to structured data describing characteristics of multiple financial products, including at least product types, cost structures, eligibility conditions, and references to underlying market instruments.

The term “market data” refers to quantitative information related to markets, including at least time-series data of prices, returns, indices, interest rates, or other market indicators relevant to financial products.

The term “statistical analysis program” refers to computer-executable instructions that perform numerical computations, such as averaging, variance calculation, regression, or time-series analysis, on historical data in order to derive indicators or parameters.

The term “machine learning program” refers to computer-executable instructions implementing one or more machine learning models or algorithms, such as regression models, classification models, or neural networks, that are trained on historical data to predict or estimate indicators related to financial products or user behavior.

The term “return indicator” refers to a quantitative measure representing an expected or historical return characteristic of a financial product, such as an expected annual return, an average historical return, or a projected growth rate.

The term “risk indicator” refers to a quantitative measure representing a risk characteristic of a financial product, such as volatility, probability of loss, maximum drawdown, or a risk score.

The term “suitability indicator” refers to a quantitative or categorical measure computed for each financial product that represents a degree of suitability of the financial product for a particular user, based at least on the user's risk tolerance, the investment period, and the return indicator and risk indicator of the financial product.

The term “context information” refers to structured or semi-structured information that provides the generative AI model with background knowledge for generating output, including at least the user profile, a ranking of financial products according to the suitability indicator, and the return indicator and risk indicator for each financial product.

The term “natural-language inquiry sentence” refers to at least one text string composed in a natural language by a user, indicating a question, request, or instruction relating to investment or financial products.

The term “prompt sentence” refers to a text string or set of text strings generated by the server and input to a generative AI model, the text string including at least the context information and the natural-language inquiry sentence in a format suitable for processing by the generative AI model.

The term “generative AI model” refers to a trained computational model, such as a generative language model, configured to receive a prompt sentence and generate natural-language output including at least proposal content and explanatory text based on the received input.

The term “proposal content” refers to structured or semi-structured information indicating one or more suggested financial products or investment options, generated by the generative AI model based on the prompt sentence.

The term “explanatory text” refers to natural-language text generated by the generative AI model that explains reasons, characteristics, or considerations related to the proposal content and the suggested financial products.

The term “output data” refers to data generated by the server for transmission to the user terminal, the data including at least financial product list information and investment policy information derived from the proposal content and the explanatory text.

The term “financial product list information” refers to data representing a list or collection of financial products included in the proposal content, including identifiers, names, and key attributes of the financial products.

The term “investment policy information” refers to information that describes recommended investment approaches, allocation policies, or behavioral guidelines for the user, derived from or associated with the proposal content.

The term “investment execution instruction” refers to a command or request received from the user terminal that indicates the user's intention to execute an investment in at least one financial product included in the proposal content.

The term “update” refers to an operation in which stored data structures, including at least the user profile and the suitability indicator, are modified based on new information, such as an investment execution instruction, so that subsequent processing uses the modified data structures.

The term “processor” refers to one or more processing units, such as central processing units or other computational units, configured to execute instructions to perform at least the acquisition of user input, quantitative analysis of historical data, generation of the prompt sentence, interaction with the generative AI model, and updating of internal data structures.

The term “server” refers to an information processing system including at least the processor and a storage unit, configured to communicate with one or more user terminals via a communication network and to perform the processing described in the claims.

In one embodiment, a server implements the claimed system using one or more general-purpose processors and memory devices. The server uses a hardware configuration including, for example, a multi-core central processing unit, a graphics processing unit, a main memory, a non-volatile storage device, and a network interface coupled via a system bus. The server executes an operating system such as a server-oriented operating system and runs middleware such as a web application framework, a database management system, and a machine learning runtime environment. The server communicates with one or more terminals operated by users over a communication network such as the Internet.

A terminal operates as a client device and can be implemented as a smartphone, a tablet, a notebook computer, or a desktop computer. The terminal executes a web browser or a native application. The terminal provides user interface screens implemented with markup language, style sheets, and scripting language or native graphical user interface components. The terminal transmits user input, including user attribute information, investment objective information, and a natural-language prompt sentence, to the server using a network protocol such as HTTPS. The terminal receives response data from the server and displays natural-language explanations, lists of financial products, and investment policy information to the user.

A user operates the terminal to input attribute information such as age, risk tolerance, investment experience, and current savings, and to input investment objective information such as target purpose and investment horizon. The user also inputs a natural-language inquiry, for example:
“I am in my 40s and I want to grow my assets while keeping risk low. Which financial products should I choose?”
“I want to prepare a university fund for my child in 18 years. My risk tolerance is low. Which investment methods are appropriate?”
“I am a 50-year-old employee and I want to balance safety and growth. How should I combine pension schemes, tax-advantaged accounts, and conservative funds?”

The terminal transmits these prompt sentences and the structured attribute fields to the server.

The server uses a program implemented, for example, in a high-level programming language running on the operating system to perform data acquisition, normalization, feature construction, statistical analysis, machine learning inference, prompt sentence generation, interaction with a generative AI model, and update of internal data structures. The server stores user-related data, product data, and historical market data in a relational database management system and optionally in an in-memory key-value store to reduce access latency.

The server constructs a user profile by normalizing and encoding the user attribute information and investment objective information into a structured data record. The server maps a numerical age to an age category by applying a predefined set of age ranges, for example mapping 42 to a “40s” category. The server transforms textual risk tolerance such as “low”, “medium”, or “high” into a numerical risk tolerance indicator on a fixed scale, for example an integer from 1 to 10. The server transforms investment horizon into a numerical investment period indicator, for example the number of months between the current date and a target date. The server writes the user profile as a record into a profile table that includes fields for a user identifier, age category, investment objective category, numerical risk tolerance indicator, and numerical investment period indicator.

The server retrieves historical data including attribute information of a plurality of financial products and market data from the database. The server maintains product tables storing product identifiers, product types, fee rates, tax treatment flags, minimum contribution amounts, eligible user types, and references to underlying market instruments. The server maintains market data tables storing time-series observations of prices, returns, index values, or interest rates. The server loads such data into main memory and performs preprocessing using a numerical computation library. The server performs operations such as sorting by timestamp, filling missing values using interpolation, calculating log returns or simple returns, aggregating returns to monthly and annual intervals, and computing statistical measures such as mean, variance, standard deviation, and maximum drawdown.

The server computes a return indicator and a risk indicator for each financial product. The server may compute a return indicator as an expected annualized return obtained from the mean of historical log returns over a specified window adjusted to an annual basis. The server may compute a risk indicator as an annualized volatility obtained from the standard deviation of daily or monthly returns, or as a maximum drawdown obtained from a time-series analysis of cumulative returns. The server stores these indicators in a product-metrics table keyed by product identifier and user-relevant horizon.

The server applies a machine learning program to further estimate user-specific suitability of financial products. In one embodiment, the server uses a supervised learning model such as a gradient-boosted decision tree model or a feedforward neural network model. The server constructs a feature vector for each product by combining product attributes and user-profile attributes. The features may include encoded product type, fee rate, tax treatment flags, historical return indicator, risk indicator, user age category, numerical risk tolerance indicator, and numerical investment period indicator. The server feeds these feature vectors into the model to generate a suitability indicator for each product, for example a score on a fixed scale or a probability that the product is suitable for the user.

In a neural network embodiment, the server uses a model having an input layer corresponding to the dimensionality of the feature vector, one or more hidden layers, and an output layer producing a suitability score. The server stores model parameters, such as weight matrices and bias vectors for each layer, in non-volatile storage. The server has previously trained this model on historical labeled data that include previous user-product pairings and outcome labels such as realized satisfaction, persistence of investment, or expert suitability ratings. During training, the server uses a loss function such as mean squared error or cross-entropy and an optimization algorithm such as stochastic gradient descent or a variant thereof. The server computes gradients of the loss with respect to model parameters via backpropagation and updates the parameters iteratively until convergence criteria are met. The server may apply regularization techniques such as weight decay or dropout and may augment training data through noise injection or resampling to improve generalization.

The server ranks the plurality of financial products according to the computed suitability indicators. The server performs a sorting operation on a list structure that pairs each product identifier with its suitability score. The server can optionally adjust the ranking by applying rule-based filters, such as removing products whose risk indicator exceeds a threshold inconsistent with the user's numerical risk tolerance indicator or whose minimum contribution exceeds a user's capacity. The server thereby produces a ranked list of candidate financial products along with associated return indicators and risk indicators.

The server generates context information including the user profile, the ranked list of financial products, and the indicators for each product. The server formats the context information as text or structured key-value pairs. For example, the server generates a context description that enumerates the user's age category, investment objective category, numerical risk tolerance indicator, numerical investment period indicator, and, for each top-ranked financial product, a name field, a product type, the return indicator, the risk indicator, and relevant conditions such as tax treatment.

The server constructs a prompt sentence for a generative AI model by integrating the context information with the natural-language inquiry sentence originally obtained from the user. The server adheres to a predefined prompt template that includes instruction segments, context segments, and the user's inquiry. The server may specify, in the instruction segment, constraints on tone, level of detail, and prohibition of guaranteed returns. The server concatenates or otherwise merges text segments into a single text string or a sequence of text strings, which constitute the prompt sentence.

The server then transmits the prompt sentence to a generative AI model. The generative AI model can be deployed as a model running on the same server hardware or as a separate inference engine accessible via a network. The generative AI model may be implemented as a large-scale language model based on a neural network architecture such as a transformer architecture. Such a model typically comprises an embedding layer, multiple attention layers, and an output layer that produces token probabilities over a vocabulary. The server supplies the prompt sentence as a sequence of tokens or token identifiers to the model via an inference API. The server receives generated tokens from the model and accumulates them into natural-language output, including proposal content and explanatory text.

In one embodiment, the generative AI model is trained or fine-tuned on domain-specific corpora, including financial explanations and regulatory-compliant language. During training, the server uses a language modeling objective that minimizes a loss function such as cross-entropy between predicted tokens and actual tokens in the training data. The server adjusts model parameters by applying gradient-based optimization. The server may also apply reinforcement learning or preference optimization based on human or rule-based feedback to teach the model to follow instructions and avoid prohibited outputs.

The server post-processes the generated output from the generative AI model. The server parses the text to identify recommended financial products mentioned by name or identifier and aligns them with entries in the ranked list stored in memory. The server may apply a rule-based filter module that checks for prohibited phrases or guarantees and replaces or omits them. The server structures the output into a response format that includes a summary, a detailed explanation, and a list of recommended products with key metrics. The server then transmits this output data to the terminal as response data.

The terminal receives the output data and renders it on the display. The terminal may show a summary paragraph explaining the overall recommendation, bullet points for each recommended product, and visualizations of projected outcomes based on the return and risk indicators. The terminal may also provide interactive controls allowing the user to drill down into product details or to specify an investment execution instruction.

The user reviews the explanation and, if desired, issues an investment execution instruction via the terminal. The terminal sends this instruction to the server. The server records the execution event in a transaction or activity table, associating the user identifier, product identifiers, amounts, and timestamps. The server updates the user profile or suitability indicators to reflect the new behavior. For example, the server can adjust the numerical risk tolerance indicator if the user repeatedly chooses higher-risk products than previously indicated, or can refine suitability model inputs by including observed preferences. The server writes updated profile values to persistent storage and may schedule retraining or incremental updating of machine learning models to incorporate new data.

This architecture and data flow provide several technical advantages beyond mere automation of human advisory tasks. The server's construction of a structured user profile, with categorical and numerical indicators derived from raw input, reduces redundancy in subsequent computations and allows reuse of the same profile across multiple recommendation requests, thereby reducing processing time and memory consumption. The server's use of dedicated statistical analysis and machine learning programs to precompute return indicators, risk indicators, and suitability indicators offloads intensive numerical computation from the generative AI model, which focuses on natural-language generation. This division improves computation efficiency and reduces the number of tokens and context length that must be processed by the generative AI model, thereby reducing latency and network bandwidth usage.

The server's prompt sentence generation mechanism, which merges structured context information and user natural-language inquiries into a single prompt, improves consistency between underlying quantitative analysis and generated text. Because the server injects precise numerical indicators and ranked product data directly into the prompt, the generative AI model can refer to this information without re-deriving it, improving accuracy and decreasing the risk of hallucinated or inconsistent recommendations. This integrated prompt generation constitutes an improvement to computer technology by optimizing cooperation between distinct computational components—a symbolic or numerical analytic pipeline and a neural language model—via a specifically engineered data interface.

The server's feedback loop, in which execution instructions captured from the terminal automatically trigger updates of the user profile and suitability indicators, enables dynamic adaptation of internal data structures and models without repeated manual re-entry of profiling data. By using structured database updates and model retraining or incremental learning techniques, the server reduces discrepancies between stored preferences and actual behavior and thus lowers error rates in subsequent recommendations. This closed-loop design improves data management by maintaining coherent, up-to-date representations that are directly usable for algorithmic processing.

The use of machine learning models with defined architectures, feature sets, loss functions, and optimization procedures further demonstrates that the system is not limited to abstract ideas. The server performs concrete transformations of data structures—mapping raw event logs, time-series market data, and user attributes into feature vectors, suitability scores, and prompt tokens—under explicit mathematical rules. The server's combination of time-series analysis for return and risk computation, feature engineering for profile and product representation, and neural-network-based generation for natural-language responses constitutes a specific, non-conventional arrangement of components that yields improved processing speed, improved recommendation coherence, and reduced communication overhead.

In alternative embodiments, the server can vary the type of machine learning model used for suitability estimation, such as replacing a gradient-boosted tree with a deep neural network including convolutional or recurrent layers to capture temporal dependencies in user behavior. The server can also vary the structure of the generative AI model, such as using a smaller or larger transformer model depending on hardware resources. The server can implement additional optimization, such as caching intermediate metrics for popular products, or batching requests from multiple users to make efficient use of hardware accelerators.

In another embodiment, the server executes the generative AI model locally on a graphics processing unit rather than calling an external inference service. In such a configuration, the server loads the model weights into GPU memory at initialization time and streams prompt tokens from the central processing unit to the graphics processing unit. The server uses specialized libraries to perform matrix multiplications and attention computations on the graphics processing unit, thereby reducing inference time. The server can also compress model parameters or use quantization techniques to fit larger models into available memory, contributing to improved resource utilization.

In yet another embodiment, the server precomputes certain prompt components, such as static instructions and common context patterns, and stores them in memory. When a new user request arrives, the server only needs to insert user-specific and product-specific segments into a pre-existing template. This reduces string construction overhead, shortens the prompt length, and decreases the amount of data transmitted to the generative AI model. As a result, the system can handle more concurrent users with the same hardware resources.

In all of these embodiments, the server, the terminal, and the user interact in a manner that is grounded in concrete data structures, algorithms, and hardware operations. The system thereby provides a specific implementation that improves computer-based investment guidance by reducing computational redundancy, increasing accuracy and consistency of generated explanations, and enhancing the efficiency of data management and machine learning workflows.

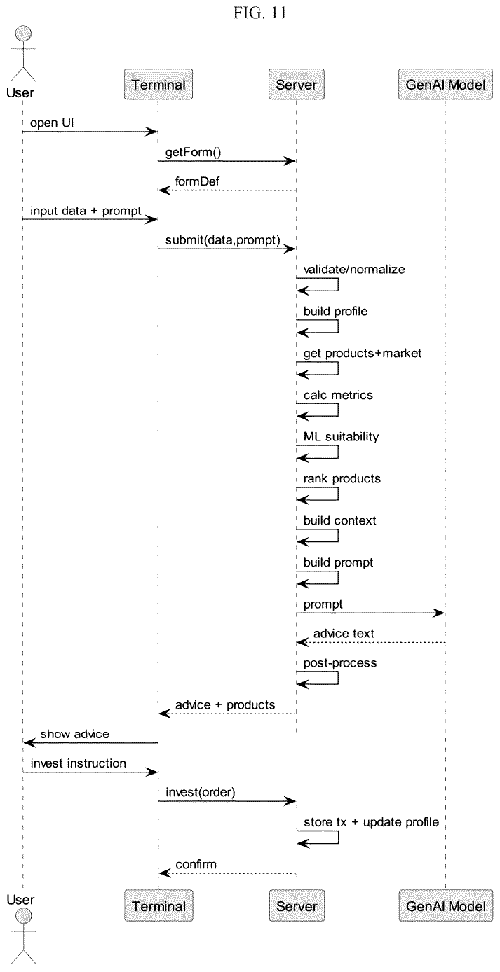

The following describes the processing flow using FIG. 11.

### Step 1:

Terminal displays an input screen for investment advice.
Terminal receives from the server a screen definition that specifies input fields for user attribute information (such as age, investment experience, and risk tolerance), investment objective information (such as target purpose and investment horizon), and a free-text area for a prompt sentence.
Input: Screen definition data from the server.
Processing: Terminal renders graphical elements (text boxes, dropdown lists, sliders, and text areas) according to the received definition, and arranges them in a layout suitable for display on the device.
Output: A visible input screen that allows the user to enter structured fields and a natural-language inquiry.

### Step 2:

User inputs profile fields and a natural-language prompt sentence.
User enters age, selects an investment objective, specifies a risk tolerance level, and sets an investment horizon, and then types a prompt sentence such as “I am in my 40s and I want to grow my assets while keeping risk low. Which financial products should I choose?”.
Input: Displayed input screen with active fields.
Processing: User operates the terminal's input devices to populate the fields and confirm the input.
Output: Filled-in form data consisting of structured attribute values and a prompt sentence maintained in terminal memory.

### Step 3:

Terminal structures and transmits the user input to the server.
Terminal collects the values from the input fields and converts them into a structured request object containing user attribute information, investment objective information, and the prompt sentence.
Input: Filled-in form data from the user interface.
Processing: Terminal maps form controls to field names (for example, “age”, “riskTolerance”, “investmentHorizon”, “promptSentence”), converts data types (for example, text to integer for age), and packages the fields into a structured message. Terminal then sends this message to the server over a secure communication channel.
Output: A structured request message transmitted to the server containing normalized text and numeric fields plus the natural-language prompt sentence.

### Step 4:

Server validates and normalizes the received user data.
Server receives the request message from the terminal and parses the contained fields.

Input: Structured request message with raw user attribute values, objective values, and prompt sentence.
Processing: Server checks each field for required presence, correct type, and allowed range (for example, age within a valid interval, horizon greater than zero). Server then normalizes values by converting textual categories (for example, “low risk”) into internal codes and converting absolute dates or durations into a standard numerical format (for example, months). Server also trims whitespace and removes invalid characters from the prompt sentence.
Output: A validated and normalized data set ready for profile construction, including cleaned user attributes, investment objectives, and a sanitized prompt sentence.

### Step 5:

Server constructs a structured user profile.
Server transforms the normalized user attributes and objectives into a user profile record suitable for computational processing.
Input: Validated and normalized attribute and objective values from Step 4.
Processing: Server applies mapping rules to derive an age category from the numerical age, an investment objective category from the selected purpose, a numerical risk tolerance indicator from the qualitative risk tolerance, and a numerical investment period indicator from the investment horizon. Server stores these values in a unified data structure and assigns an internal user profile identifier.
Output: A structured user profile object stored in server memory and optionally persisted in a profile database.

### Step 6:

Server retrieves financial product data and historical market data.
Server accesses repositories of financial product information and associated market data to prepare for quantitative analysis.
Input: User profile object and product identifiers or product categories managed by the system.
Processing: Server queries a product catalog to obtain attributes of multiple financial products, such as product type, fees, tax treatment, and eligibility constraints. Server also queries market data stores for time-series information related to the underlying instruments of those products. Server aggregates records by product identifier and time.
Output: A collection of product attribute records and aligned market time-series data loaded into server memory.

### Step 7:

Server preprocesses historical market data and computes base indicators.
Server transforms raw market data into metrics suitable for risk and return estimation.
Input: Market time-series data and product attribute records from Step 6.
Processing: Server orders time-series data by date, fills missing values using interpolation or forward-filling, and calculates periodic returns (for example, daily or monthly returns). Server then computes base statistics such as average periodic return, variance, standard deviation, and cumulative loss sequences needed for drawdown analysis.
Output: For each financial product, a set of base statistical measures derived from historical market data.

### Step 8:

Server calculates return indicators and risk indicators for each financial product.
Server transforms the base statistical measures into user-relevant indicators.
Input: Base statistical measures for each financial product from Step 7 and user-relevant horizon information from the user profile.
Processing: Server computes an annualized or horizon-aligned return indicator based on average returns and compounding assumptions, and derives one or more risk indicators such as annualized volatility or maximum drawdown over a period corresponding to the user's investment horizon. Server may scale or normalize these indicators to consistent units.
Output: A set of return indicators and risk indicators associated with each financial product and stored in a metrics structure.

### Step 9:

Server constructs feature vectors and evaluates product suitability using a machine learning program.
Server prepares numerical representations for each product-user pair and uses a learned model to estimate suitability.
Input: Product attributes, return indicators, risk indicators, and user profile from previous steps.
Processing: Server creates feature vectors that encode product type, fee values, tax flags, computed return and risk indicators, age category encoding, numerical risk tolerance indicator, and numerical investment period indicator. Server passes these feature vectors through a trained model such as a decision tree ensemble or a neural network and receives suitability scores as outputs.
Output: A suitability indicator for each financial product, forming a list of products with their corresponding suitability scores for the given user profile.

### Step 10:

Server ranks financial products based on suitability and constraints.
Server orders products and filters them according to user constraints and risk alignment.
Input: Suitability indicators, return indicators, risk indicators, and user constraints from the user profile.
Processing: Server sorts products by suitability indicator in descending order, applies threshold filters on risk indicators relative to the numerical risk tolerance indicator, and removes products that violate eligibility or contribution constraints. Server may apply tie-breaking rules when multiple products share similar scores.
Output: A ranked and filtered list of candidate financial products tailored to the user's profile.

### Step 11:

Server generates context information for prompt construction.
Server converts structured analysis results into a context description suitable for use by a generative AI model.
Input: User profile object and ranked list of candidate financial products with their indicators.
Processing: Server formats the user profile into descriptive text and formats each top-ranked product into a concise summary including product type, return indicator, risk indicator, fee level, and tax treatment. Server combines these pieces into a context block that presents the user's situation and the analytical results in a machine-readable textual form.
Output: A context information block containing profile description and summarized product data.

### Step 12:

Server constructs a prompt sentence for the generative AI model.
Server merges the context information with the user's natural-language inquiry to form a single prompt.
Input: Context information block from Step 11 and sanitized prompt sentence from Step 4.
Processing: Server inserts the context and user inquiry into a prompt template that also includes instructions about style and compliance (for example, not to guarantee returns). Server concatenates the segments into a complete prompt sentence or prompt text sequence formatted for the generative AI model's interface.
Output: A composed prompt sentence ready to be sent to the generative AI model.

### Step 13:

Server sends the prompt sentence to the generative AI model and obtains generated text.
Server performs inference by interacting with the model via a dedicated interface.
Input: Composed prompt sentence from Step 12.
Processing: Server transmits the prompt sentence to the generative AI model, either locally or over a network. The model processes the prompt and generates output tokens that form proposal content and explanatory text. Server receives the token stream and reconstructs it into complete natural-language strings.
Output: Generated proposal content and explanatory text describing recommended financial products and reasoning.

### Step 14:

Server post-processes the generated content and structures response data.
Server aligns model output with internal product records and applies presentation rules.
Input: Generated proposal content and explanatory text from Step 13, and the ranked product list from Step 10.
Processing: Server parses the text to identify references to specific financial products and associates them with internal identifiers. Server may insert additional numeric values such as return and risk indicators into the explanation, remove prohibited phrases, and structure the information into sections like summary, detailed explanation, and product list.
Output: Structured response data containing refined proposal content, explanatory text, and aligned product information.

### Step 15:

Server transmits the response data to the terminal.
Server sends the formatted recommendation back to the client device for display.
Input: Structured response data from Step 14 and the user's session or connection information.
Processing: Server encapsulates the response data into a message format suitable for the terminal, such as a structured response, and sends it over the established secure connection.
Output: Response message delivered to the terminal containing recommendations, explanations, and product details.

### Step 16:

Terminal displays the recommendation to the user.
Terminal renders the received data in a human-readable format.
Input: Response message from the server containing proposal content, explanatory text, and product information.
Processing: Terminal parses the message, populates user interface elements with the summary, detailed explanation, and product list, and optionally renders charts or tables based on numeric indicators.
Output: A displayed recommendation screen that presents the generative AI model's advice and the associated analytics to the user.

### Step 17:

User reviews the recommendation and optionally issues an investment execution instruction.
User interacts with the recommendation and may choose specific actions.
Input: Displayed recommendation screen from the terminal.
Processing: User reads the explanatory text, inspects details for each product, and, if desired, selects one or more products and specifies investment amounts through the terminal interface.
Output: A user decision, which may include an investment execution instruction, captured by the terminal as new input.

### Step 18:

Terminal sends an investment execution instruction to the server.
Terminal converts the user's selection into a machine-readable instruction message.
Input: User selections and specified investment amounts from the displayed interface.
Processing: Terminal structures the chosen products and amounts into an instruction message, associates it with the user session or account, and sends it to the server over the secure communication channel.
Output: An investment execution instruction message transmitted to the server.

### Step 19:

Server processes the investment execution instruction and updates internal data.
Server records the execution and adjusts profile-related data structures.
Input: Investment execution instruction message from Step 18 and existing user profile and product data.
Processing: Server verifies the instruction against eligibility and consistency checks, records the transaction in a database, and updates elements of the user profile or associated suitability indicators to reflect the user's actual investment behavior. Server stores the updated values and marks them as the basis for future analysis and prompt construction.
Output: Updated user profile data and suitability indicators stored on the server, and a confirmation status that can be returned to the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented investment support systems typically rely on static rule-based engines or simple scoring logic executed by a processor in order to recommend financial products to users. Such systems generally process user profile data and basic financial parameters in isolation, and output a generic recommendation without leveraging rich historical financial behavior or dynamically generated explanations. As a result, several technical problems arise in the operation of these computer systems.

First, the processor often performs inefficient and fragmented data processing. User transaction history and expenditure history are stored in a storage device but are not systematically transformed into structured feature information suitable for machine learning. The lack of an integrated pipeline for preprocessing and feature extraction forces the system either to ignore valuable historical data or to perform ad hoc queries and calculations, which leads to increased computational overhead, duplicated processing, and poor scalability as the volume of data grows.

Second, the system typically employs a fixed decision tree or hand-crafted rules rather than a trained machine learning model. This prevents the processor from adapting to new data patterns or from efficiently mapping complex, high-dimensional financial behavior data to optimal asset management means. As a consequence, the computer system fails to fully utilize available computational resources, underperforms in prediction accuracy, and requires frequent manual updates of rules by human operators.

Third, conventional systems do not effectively use generative artificial intelligence models as a back-end computation resource integrated with machine learning outputs. Even when a generative AI model is present, it is usually invoked with manually written or generic prompt sentences, not with structured prompt sentences that systematically embed machine learning outputs, processed feature information, and user-specific investment parameters. This results in inconsistent and sometimes irrelevant generated explanations, which in turn diminishes the usefulness of the system and wastes network bandwidth and processing time.

Fourth, known systems lack a closed feedback loop that uses user selections of recommended asset management means as learning data for future model updates. Without recording user selection results in a structured manner and accumulating them as learning data, the processor cannot improve the prediction performance of the machine learning model over time. This leads to a static system behavior that cannot evolve as user behavior and market conditions change, thereby limiting the technical effectiveness of the system.

Accordingly, there is a need for a computer-implemented system in which a processor efficiently obtains user input information and historical information from a storage device, preprocesses and transforms the historical information into feature information using a data analysis library, executes a machine learning model to predict recommended asset management means based on the feature information, and cooperatively uses a generative artificial intelligence model via a structured prompt sentence that embeds machine learning results and user-specific parameters. There is further a need for a system that records user selection results as learning data so that the processor can continuously improve the machine learning model. By addressing these problems, the present invention aims to improve the operation of the computer itself, including data processing efficiency, recommendation accuracy, adaptability, and the quality and consistency of generated explanations.

The specific processing by the specific processing unit 290 of the data processing device 12 in Application Example 1 is realized by the following means.

The present invention provides a server comprising a processor and a storage device, wherein the processor is configured to obtain, from the storage device, input information received from a user including at least an investable amount, an investment objective, an investment tolerance level, and an investment period, and historical information including at least transaction history information and expenditure history information; to process the historical information using a data analysis library to perform preprocessing and feature extraction so as to generate feature information representing at least an investment behavior tendency and an expenditure tendency of the user; to execute, based on the feature information and the investment tolerance level, a machine learning model configured by using a machine learning library so as to predict at least one of a plurality of asset management means as a recommended asset management means; to generate, by using the recommended asset management means, the investable amount, the investment objective, and the investment tolerance level, a prompt sentence that defines a request content for explanation to a generative artificial intelligence model, the prompt sentence including evaluation information comprising an output result of the machine learning model; to transmit the prompt sentence to an external generative artificial intelligence model so as to cause the external generative artificial intelligence model to generate an explanation text regarding the recommended asset management means; to generate output data including the recommended asset management means and the explanation text for output to a user terminal device; and to record, in the storage device, a selection result of the recommended asset management means received from the user terminal device and accumulate the selection result as learning data for future training of the machine learning model. This enables the server to implement an integrated and technically improved data processing pipeline that transforms raw financial history into machine-learning-ready feature information, to compute recommended asset management means with higher accuracy and adaptability, to generate consistent and user-specific explanation texts by coordinated use of the machine learning model and the generative artificial intelligence model via structured prompt sentences, and to continuously enhance model performance by feeding back user selection results as training data, thereby improving the overall functionality and efficiency of the computer-implemented investment support system.

The term “asset management means” refers to a financial arrangement or investment vehicle used for managing and increasing assets, including, but not limited to, schemes that prescribe rules for periodic contributions, tax treatment, and investment targets, and that can be selected and recommended by the system as part of a user's investment strategy.

The term “user” refers to an individual or entity that interacts with the system via a terminal device, provides investment-related input information such as financial parameters and objectives, and receives recommended asset management means and explanation texts from the system.

The term “attribute information” refers to information representing characteristics of a user, including at least age, income range, investment experience, investment horizon, and other profile data relevant to determining an appropriate asset management strategy.

The term “financial information” refers to information related to the user's financial status, including at least assets, liabilities, income, expenditures, and investable amounts, which is used by the system to assess the user's investment capability and constraints.

The term “investable amount” refers to a monetary amount, such as a monthly or periodic amount, that the user indicates can be allocated to asset management means without impairing necessary living expenses or other financial obligations.

The term “investment objective” refers to a goal or purpose of investing specified by the user, including, but not limited to, long-term asset growth, preparation for retirement, education funding, or risk diversification.

The term “investment tolerance level” refers to an indicator of the degree of variability in investment value or risk that the user is willing and able to accept, which may be expressed in categories such as low, medium, or high, or as a numerical score.

The term “investment period” refers to a time horizon over which the user intends to maintain an investment, such as a number of years until a target event, and which is used by the system to select or evaluate asset management means.

The term “transaction history information” refers to historical data records of past investment transactions of the user, including at least transaction dates, transaction amounts, types of financial instruments, and resulting balances.

The term “expenditure history information” refers to historical data records of past spending activities of the user, including at least payment dates, amounts, and categories of expenditure, which are used to infer expenditure tendencies and available surplus for investment.

The term “historical information” refers to a collection of past data associated with the user, including at least transaction history information and expenditure history information, that is stored in a storage device and used for analysis and feature extraction.

The term “storage device” refers to a non-transitory computer-readable medium, such as a magnetic disk, solid-state drive, or other persistent memory device, configured to store input information, historical information, feature information, model parameters, and learning data used by the system.

The term “data analysis library” refers to a software component or set of program modules executed by the processor that provides functions for data loading, cleaning, transformation, aggregation, and statistical calculation, and that is used to preprocess historical information and generate feature information.

The term “feature information” refers to structured numerical or categorical data derived from raw historical information by preprocessing and feature extraction, and representing characteristics such as investment behavior tendency and expenditure tendency of the user in a form suitable for input to a machine learning model.

The term “investment behavior tendency” refers to a pattern or characteristic of how a user has historically conducted investment activities, including at least frequency of transactions, preferred asset types, typical contribution levels, and response to market fluctuations.

The term “expenditure tendency” refers to a pattern or characteristic of how a user has historically spent funds, including at least distributions of expenditure across categories, average monthly spending, and variability of discretionary spending.

The term “machine learning model” refers to a computational model generated by a training process using historical data and a machine learning algorithm, which receives feature information and related parameters as input and outputs a prediction or classification regarding recommended asset management means.

The term “machine learning library” refers to a software framework or collection of program modules that provides implementations of machine learning algorithms, training procedures, model persistence, and inference functions, and that is executed by the processor to configure and run the machine learning model.

The term “recommended asset management means” refers to at least one asset management means predicted or selected by the machine learning model, based on feature information and an investment tolerance level, as being suitable for the user under current conditions.

The term “generative artificial intelligence model” refers to a trained computational model that generates natural language or other content in response to an input prompt sentence, and that is used by the system to produce explanation texts or confirmation messages related to the recommended asset management means.

The term “prompt sentence” refers to a structured text string generated by the processor that specifies an instruction, context, or request content for the generative artificial intelligence model, and that may include evaluation information, user-specific parameters, and identification of recommended asset management means.

The term “evaluation information” refers to information included in or derived from an output result of the machine learning model, such as predicted labels, confidence scores, or ranking of asset management means, which is embedded in a prompt sentence and provided to the generative artificial intelligence model.

The term “explanation text” refers to a natural-language description generated by the generative artificial intelligence model in response to a prompt sentence, the description including at least reasons for selecting a recommended asset management means, advantages thereof, and points to be noted by the user.

The term “output data” refers to a data structure generated by the processor that includes at least identification of the recommended asset management means and the associated explanation text, and that is formatted for transmission to and presentation on a user terminal device or display device.

The term “user terminal device” refers to an electronic apparatus operated by the user, such as a smartphone, tablet, or personal computer, which is configured to communicate with the server, send input information to the server, and display output data including recommendations and explanation texts.

The term “selection result” refers to information indicating which recommended asset management means, if any, has been chosen by the user via the user terminal device, optionally including parameters such as contribution amount or start date.

The term “learning data” refers to data stored in the storage device and used for training or updating the machine learning model, including at least feature information, recommended asset management means, and corresponding selection results made by users.

The term “server” refers to a computing apparatus comprising at least one processor and at least one storage device, configured to perform data acquisition, preprocessing, feature extraction, machine learning-based prediction, prompt generation, communication with a generative artificial intelligence model, and delivery of output data to user terminal devices.

In one embodiment, a server implements an investment support system that cooperates with one or more terminals operated by users. The server includes at least one processor, a main memory, a non-transitory storage device, and a network interface. The terminal includes at least one processor, a display device, an input device such as a touch panel or keyboard, a memory, and a communication module for connecting to the server through a network. The user operates the terminal to provide financial information and to receive recommended asset management means and explanation texts from the server.

The server executes a program stored in the storage device and loaded into the main memory. The program is implemented in a high-level programming language such as a scripting language, and uses software libraries including a data analysis library (for example, a tabular data processing library), a numerical computation library, and a machine learning library (for example, a library providing implementations of decision trees, random forests, gradient boosting, and neural networks). The server also communicates with an external generative AI model provided over a network via an application programming interface (API).

The server stores, in the storage device, user-related data structures including at least: (i) a user profile table, (ii) a transaction history table, (iii) an expenditure history table, (iv) a feature table, (v) a model output table, and (vi) a learning data table. Each table can be realized in a relational database management system. The user profile table holds records keyed by a user identifier, each record including fields for age, income range, investment experience level, investment horizon, and other attribute information. The transaction history table holds entries comprising a user identifier, a transaction timestamp, a transaction amount, a financial instrument category, and a resulting balance. The expenditure history table holds entries comprising a user identifier, an expenditure timestamp, an expenditure amount, and a category code such as housing, food, utilities, insurance, or discretionary spending. The feature table holds feature vectors generated for each user request, where each vector comprises normalized numerical features and encoded categorical features derived from the historical information. The model output table holds, for each feature vector, the predicted recommended asset management means and associated confidence scores or ranking values. The learning data table stores associations between feature vectors, model outputs, and actual selection results received from users.

The server uses the data analysis library in order to convert raw transaction history information and expenditure history information into structured feature information. The server loads, into memory, data blocks containing a plurality of history records for a user, and organizes them into a tabular in-memory structure. The server applies preprocessing operations including type conversion, missing-value imputation, currency normalization, and time indexing. The server then applies aggregation operations, such as grouping by month or expenditure category, computing statistical measures including mean, variance, maximum, minimum, and moving averages, and constructing custom metrics such as monthly surplus (income minus expenditure), proportion of discretionary spending, and volatility of past investment contributions.

The server encodes the resulting metrics into a feature vector having a fixed length, where each position of the vector corresponds to a specific feature definition. For example, one element may represent a normalized average monthly surplus over the last twelve months, another element may represent the standard deviation of monthly investment contributions, another element may represent a categorical code for the user's declared investment tolerance level, and another element may represent the remaining investment horizon in months. The server uses numerical scaling methods, such as min-max normalization or standardization, implemented by the numerical computation library, to ensure that different features fall within a comparable numerical range. By imposing a consistent feature schema, the server enables efficient vectorized computation and reduces cache misses, thereby improving processing speed compared to ad hoc per-request calculations.

The server executes a machine learning model using the machine learning library. In one embodiment, the machine learning model is a gradient boosting decision tree model trained to map feature vectors to a discrete set of asset management means. The server stores the trained model parameters, such as tree structures, node split thresholds, and leaf values, in the storage device. At runtime, the server loads the model into memory and performs inference by traversing the decision trees for each feature vector. In another embodiment, the server uses a neural network configured as a multi-layer perceptron, including an input layer receiving the feature vector, one or more hidden layers with nonlinear activation functions such as rectified linear units, and an output layer producing a probability distribution over candidate asset management means. The server stores the neural network weights and biases as floating-point arrays and performs matrix multiplications and activation evaluations using the numerical computation library, which may exploit optimized linear algebra routines.

The server trains or updates the machine learning model using supervised learning. The server constructs training samples by pairing feature vectors stored in the feature table with ground truth labels derived from user selection results stored in the learning data table. The server defines a loss function, such as cross-entropy loss for classification, and executes an optimization algorithm, such as stochastic gradient descent or a variant thereof, to update the model parameters. During each training iteration, the server computes the model output for a batch of feature vectors, evaluates the loss, computes gradients of the loss with respect to model parameters, and applies parameter updates. The server repeats this process until a convergence criterion is met, such as stabilization of validation loss or attainment of a maximum number of epochs. By using the recorded user selection results as learning data, the server causes the model to adapt over time to actual user preferences and behavior patterns, thereby reducing prediction error and improving recommendation accuracy.

The server generates a prompt sentence for a generative AI model by combining machine learning model outputs with user-specific parameters in a structured manner. The server constructs a text template with segments allocated for the user's monthly investable amount, investment tolerance level, investment objective, and the recommended asset management means as predicted by the machine learning model. The server inserts the actual values into these segments to produce a structured natural language instruction. For example, the server may generate a prompt sentence as follows:
“The user's monthly investable amount is 50,000 yen, the investment tolerance level is medium, and the investment objective is long-term retirement savings. The machine learning model recommends a tax-preferential long-term installment-type asset management scheme as the optimal asset management means. Explain, in an easy-to-understand manner, the reasons for selecting this asset management means, the advantages and potential risks, and practical steps for the user to start using this scheme.”

In another example, the server may generate a prompt sentence of the following form: “A user can invest 30,000 yen per month and has a low investment tolerance level. Based on the user's transaction and expenditure history, the machine learning model recommends an investment scheme having a non-taxable limit for a contribution amount. Describe why this scheme is suitable, how the monthly contribution could be allocated, and what points the user should pay attention to.”

The server transmits the prompt sentence to an external generative AI model. The server encapsulates the prompt sentence in a request message and sends the request via the network interface using a secure protocol. The external generative AI model may be implemented as a large-scale neural network such as a transformer architecture, including an encoder-decoder structure or a decoder-only structure with self-attention layers, multiple attention heads, and feedforward layers. The external generative AI model receives the prompt sentence as input tokens and computes contextualized representations through stacked attention layers, then generates an explanation text token-by-token based on probability distributions over a vocabulary. The generative AI model may be trained using an unsupervised or semi-supervised learning method on a large corpus of text, and optionally fine-tuned for instruction-following. The server does not treat the generative AI as a black box; instead, the server constrains and structures the input to the generative AI model via the prompt sentence so that the resulting output is tightly aligned with the machine learning prediction and the user's parameters.

The server receives the generated explanation text from the external generative AI model and performs post-processing. The server removes extraneous characters, converts the text into a standardized encoding, and applies length control, such as truncation or segmentation into paragraphs of bounded size. The server then stores the explanation text in association with the corresponding recommended asset management means and user request identifier. By storing this association, the server can later analyze which explanation styles correlate with higher user acceptance, and can refine prompt sentence templates accordingly.

The terminal presents the recommended asset management means and the explanation text to the user in a structured user interface. The terminal displays the identity of the recommended asset management means, such as “tax-preferential long-term installment-type asset management scheme,” along with key attributes like contribution limits, tax effects, and typical investment horizon. The terminal shows the explanation text in a readable layout, and may allow the user to expand sections for more details or to request a summary. The user can compare multiple asset management means if the server outputs secondary recommendations, and can select one of them by manipulating a graphical control element.

The server records the user's selection result in the storage device. When the user confirms a choice on the terminal, the terminal sends a selection message to the server, which writes a new record into the learning data table. The record includes the feature vector that was used for prediction, the model's recommended asset management means, the user's actual selection, and optional feedback such as whether the user requested an alternative explanation. The server may also update a timestamp indicating the latest user interaction. By accumulating such records, the server builds a dataset that captures the relationship between model recommendations, explanations, and user decisions.

The server improves computer performance and resource utilization through its specific data structures and processing pipeline. Because the server computes feature vectors in a standardized numeric format and stores them in the feature table, repeated requests by the same user can reuse existing features with incremental updates rather than recomputing all metrics from raw history. This reduces disk access operations and CPU time, and allows batching of multiple inference requests for vectorized processing. The server's use of a machine learning library with compiled numerical kernels enables efficient execution on general-purpose processors, and can be extended to use hardware acceleration on specialized instruction sets, thereby improving throughput and latency over naive rule-based implementations.

The server reduces network and computational load for the external generative AI model by generating compact and precise prompt sentences. Instead of sending entire transaction and expenditure histories as context, the server sends only summarized evaluation information and selected user parameters. This design lowers the size of request messages and reduces the number of tokens that the generative AI model must process, which in turn decreases inference time and usage cost while preserving explanation quality. Furthermore, by aligning the prompt sentence with the machine learning model output, the server reduces the likelihood of irrelevant or inconsistent generated text, minimizing the need for repeated requests or manual correction.

The system thus goes beyond mere automation of human judgment. A human financial advisor would typically read raw financial statements and write explanations manually, without converting data into standardized feature vectors or running high-dimensional models to predict asset management means. In contrast, the server applies a non-conventional sequence of steps: automated feature extraction from large-scale historical data using a data analysis library, prediction by a trained machine learning model optimized through gradient-based learning, and controlled invocation of a generative AI model using structured prompt sentences embedding machine learning outputs. This pipeline modifies how the computer processes and stores data, how it uses processor and memory resources, and how it communicates over the network, resulting in improved speed, scalability, accuracy, and reliability.

In alternative embodiments, the server may employ different machine learning algorithms, such as random forests, support vector machines, or convolutional neural networks configured for time series data. The server may also segment users into clusters using unsupervised methods such as k-means clustering or Gaussian mixture models and then apply cluster-specific models. The feature set may be extended to include macroeconomic indicators or market volatility indices retrieved from external data feeds. The prompt sentence templates may be adjusted for different languages or regulatory environments, while still maintaining the structure in which machine learning evaluation information and user-specific parameters are explicitly integrated.

In another embodiment, the terminal may locally cache certain explanation texts and user interface components to reduce repeated network calls. The terminal may also collect interaction metrics, such as how long the user spends reading specific sections of the explanation, and send summarized interaction features back to the server. The server can then correlate these interaction features with selection results in the learning data, enabling further refinement of both the machine learning model and the prompt sentence templates.

The server and the terminal cooperate to implement a technical solution that optimizes the internal operation of the computer system. By structuring user financial data into feature vectors, using a machine learning model to generate evaluation information, and using a generative AI model guided by a precisely formed prompt sentence, the system achieves improved computational efficiency, reduction of redundant data processing, enhanced consistency of outputs, and adaptive learning from user behavior. These technical effects arise from the specific combination of data structures, processing steps, and interaction patterns between the server, the terminal, the machine learning model, and the generative AI model.

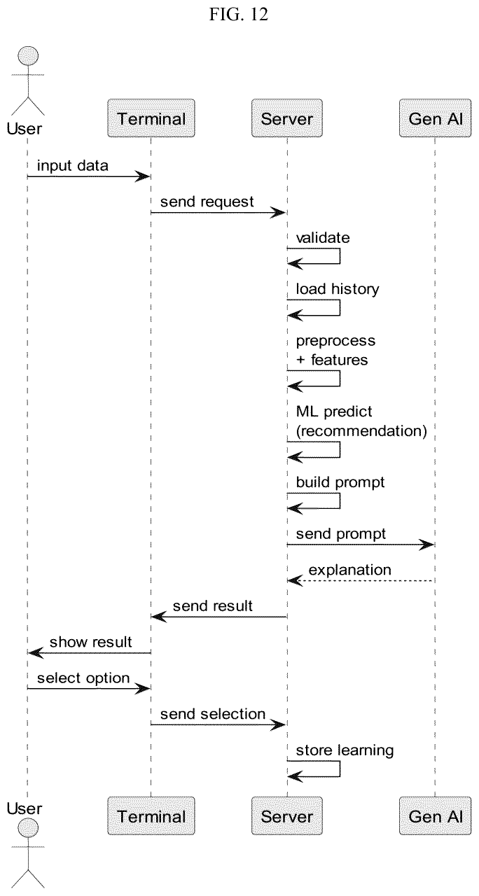

The following describes the processing flow using FIG. 12.

### Step 1:

The user operates the terminal to input investment-related information.
The user enters, via a graphical user interface on the terminal, an investable amount (for example, a monthly amount), an investment objective, an investment tolerance level, an investment period, and optional profile information such as age and investment experience.
The terminal receives this input as structured data (for example, key-value pairs), validates basic formats (e.g., numeric fields for amounts and periods), and prepares a request message. The input of this step is the user's raw input values from the UI components, and the output is a structured request object in the terminal's memory that encapsulates the user's investment parameters.

### Step 2:

The terminal transmits the structured request to the server.
The terminal converts the request object into a serialized message, attaches a user identifier or session identifier, and sends the message to the server via a network interface using a secure communication protocol. The input of this step is the structured request object held by the terminal, and the output is a network message containing the user's investment parameters delivered to a designated endpoint on the server.

### Step 3:

The server receives and validates the user request.
The server parses the incoming message, extracts fields such as investable amount, investment objective, investment tolerance level, and investment period, and checks that required fields are present and within allowable ranges. The server performs data type validation and may normalize categorical values into predefined codes. The input of this step is the network message received from the terminal, and the output is a validated internal representation of the user request, which is stored in server memory and optionally logged in the storage device.

### Step 4:

The server retrieves historical information from the storage device.
The server uses the user identifier to query a database and fetch transaction history information and expenditure history information. The server issues data retrieval commands to obtain records including timestamps, amounts, categories, and balances. The input of this step is the validated user identifier and query parameters derived from the user request, and the output is one or more sets of historical records loaded into memory in a raw tabular or record format.

### Step 5:

The server preprocesses historical information using a data analysis library.
The server converts the raw history records into in-memory tabular structures and performs preprocessing operations such as timestamp parsing, sorting by time, missing-value imputation, and currency normalization. The server groups records by time intervals and categories, computing aggregates such as monthly totals, averages, and variances. The input of this step is the raw historical records retrieved from the storage device, and the output is cleaned and organized tabular data structures that are ready for feature extraction.

### Step 6:

The server extracts feature information representing behavior tendencies.
The server applies mathematical operations to the preprocessed data to generate numerical and categorical features, including investment behavior tendency and expenditure tendency. For example, the server calculates average monthly surplus, standard deviation of monthly investment amounts, ratios of category-specific spending, and recent trend indicators. The server encodes these metrics into a fixed-length feature vector and may apply normalization or scaling. The input of this step is the preprocessed tabular data from Step 5 and the user's declared tolerance level and investment period, and the output is a standardized feature vector stored in server memory and optionally recorded in a feature table.

### Step 7:

The server executes a machine learning model to predict a recommended asset management means.
The server loads a trained machine learning model and feeds the feature vector as input. The server performs model inference by applying the model's internal operations, such as traversing decision trees or computing neural network layer outputs, to produce a prediction.
The server obtains a label representing a recommended asset management means and may also obtain confidence scores or a ranked list of candidates. The input of this step is the feature vector generated in Step 6 and the trained model parameters stored in the storage device, and the output is a prediction result containing at least one recommended asset management means and associated evaluation information.

### Step 8:

The server formats evaluation information and user parameters for explanation generation.
The server composes a data structure that combines the machine learning model output (for example, the recommended asset management means and confidence scores) with the user's parameters (investable amount, investment objective, tolerance level, and investment period).
The server may also include derived indicators such as monthly surplus or volatility values. The input of this step is the prediction result from Step 7 and the internal representation of the user request, and the output is an explanation context structure that organizes all necessary information for prompt generation.

### Step 9:

The server generates a prompt sentence for a generative AI model.
The server selects a text template corresponding to the user's language and context, and interpolates elements from the explanation context structure into the template. The server assembles a natural-language instruction describing the user's situation, the recommended asset management means, and the desired content of the explanation. The input of this step is the explanation context structure created in Step 8, and the output is a prompt sentence string that will be transmitted to the generative AI model.

### Step 10:

The server transmits the prompt sentence to a generative AI model and receives an explanation text.
The server constructs a request message containing the prompt sentence and sends it to an external generative AI model via an API. The generative AI model processes the prompt sentence and returns a generated explanation text. The server receives the response, parses out the relevant text field, and stores it in memory. The input of this step is the prompt sentence produced in Step 9, and the output is a raw explanation text generated by the generative AI model and available to the server for further use.

### Step 11:

The server post-processes the explanation text and prepares output data.
The server refines the explanation text by trimming excessive length, correcting encoding, and optionally segmenting the text into structured sections (for example, “reasons,” “advantages,” and “risks”). The server then constructs an output data object including at least the recommended asset management means, any secondary options, key numerical parameters (such as investable amount and horizon), and the processed explanation text. The input of this step is the raw explanation text from Step 10 and the prediction result from Step 7, and the output is a structured output data object formatted for transmission to the terminal.

### Step 12:

The server sends the output data to the terminal.
The server serializes the output data object into a response message and transmits it through the network interface to the terminal that originated the request. The input of this step is the structured output data object from Step 11, and the output is a network response sent to the terminal, containing all information needed for presenting recommendations to the user.

### Step 13:

The terminal receives and renders the recommendation and explanation.
The terminal parses the response message, extracts fields such as the recommended asset management means and the explanation text, and updates the user interface accordingly. The terminal displays the recommended means in a prominent area, shows associated parameters, and presents the explanation text in a readable format. The input of this step is the response message sent from the server in Step 12, and the output is a visual representation of the recommendation and explanation on the terminal's display.

### Step 14:

The user reviews the displayed information and selects an asset management means.
The user reads the explanation and examines the recommended asset management means and any alternatives presented on the terminal screen. The user then chooses one of the options or decides not to proceed, by selecting a control element such as a button or checkbox. The input of this step is the visual information displayed on the terminal as a result of Step 13, and the output is a user selection action captured by the terminal's input device as a new selection event.

### Step 15:

The terminal sends the user's selection result to the server.
The terminal converts the selection event into a structured message, including identifiers of the chosen asset management means, the associated request identifier, and optionally additional user feedback. The terminal transmits this message to the server via the network interface. The input of this step is the selection event generated in Step 14, and the output is a selection result message delivered to the server for recording and learning.

### Step 16:

The server records the selection result and updates learning data.
The server receives the selection result message, links it to the corresponding feature vector and prediction record, and writes a new entry into the learning data table. The server may update summary statistics or flags indicating whether the user accepted the primary recommendation. The input of this step is the selection result message from Step 15 and the stored prediction context from previous steps, and the output is an updated set of learning data records that reflect the user's decision and are available for future training or evaluation of the machine learning model.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented investment advisory systems generally rely on fixed rule sets, static scoring algorithms, or manually crafted recommendation logic executed by generic processors. Such systems treat investor transaction history, market data, and user preferences as simple input parameters to be fed into predetermined formulas. As a result, these systems exhibit limited adaptability to complex, time-varying market environments and diverse user behaviors, and they do not fully exploit advances in machine learning or generative AI models at the system level.

In many existing architectures, different types of investment-related data are processed in isolated pipelines. User transaction history may be stored in one data structure, external market data in another, and user profile data in yet another, without a unified representation optimized for subsequent AI processing. This fragmented data handling forces the processor to perform repetitive data conversions and ad-hoc feature engineering each time an investment strategy is to be generated, thereby increasing latency, resource consumption, and complexity of the code base. Moreover, typical systems do not structure their internal prompts or instructions to generative AI models in a systematic, machine-optimized manner, causing under-utilization of the capabilities of such models.

Further, conventional systems usually ignore temporal signals related to the user's state, such as behavioral changes over time or sensor-derived indicators reflecting stress or confidence. Even when some form of “sentiment” is considered, it is often handled superficially at the user interface layer, rather than being integrated as a core parameter that programmatically shapes the machine-generated strategy. As a result, the processor cannot dynamically adjust risk levels and asset allocations in a principled, algorithmic way based on real-time user state estimation.

Additionally, systems that incorporate historical expertise of successful investors generally implement such knowledge as static templates or pre-written guidance text. These approaches do not provide a robust, machine-usable knowledge base that can be programmatically referenced and combined with generative AI outputs. Consequently, historical expert knowledge is not tightly integrated into the computational pipeline, and the processor cannot perform systematic correction or refinement of AI-generated strategy candidates based on that knowledge.

In summary, there is a need for a computer system and a processing architecture that (i) unifies heterogeneous investment-related data into structured behavior and risk profiles suitable for AI processing, (ii) programmatically constructs and uses prompt sentences to control generative AI models, (iii) incorporates a machine-usable knowledge base of past investment entities into the refinement of AI outputs, and (iv) continuously estimates and uses user state information, including emotional aspects, to algorithmically adjust risk levels and allocations. Such a system would improve the technical functioning of the computer-based advisory platform itself, by optimizing data structures, control flows, and interactions between the processor and generative AI components, thereby reducing processing overhead, enabling more precise control of AI behavior, and achieving more adaptive and context-aware investment strategy generation.

The specific processing by the specific processing unit 290 of the data processing device 12 in Example 2 is realized by the following means.

The present invention provides a server comprising a processor and a storage device, the processor being configured to integrate investment transaction history information acquired from a user terminal and market-related information acquired from an external information providing apparatus, to store the integrated information in the storage device, and to generate investment behavior characteristic information and risk characteristic information as structured internal representations optimized for subsequent AI processing; to generate, based on the investment behavior characteristic information, the risk characteristic information, and the market-related information, a prompt sentence that explicitly instructs a generative AI model to generate investment strategy evaluation information including investment target information and investment allocation information; to execute the generative AI model by using the prompt sentence and the investment behavior characteristic information as machine-readable input, thereby acquiring investment strategy candidate information; to maintain, in the storage device, a knowledge base including investment history information and investment policy information of past investment entities, and to algorithmically reference the knowledge base so as to correct and refine the investment strategy candidate information as investment knowledge referenced investment strategy information; to estimate user state information over time based on operation information from the user terminal and sensor information, and to programmatically adjust a risk level and an asset allocation included in the investment strategy candidate information in accordance with the user state information as an emotion state estimation process; and to output, to the user terminal, investment strategy information obtained by the emotion state estimation process as an investment strategy presentation process. This enables improved computer functionality for investment advisory processing by providing a unified data model for heterogeneous investment-related information, by enabling precise, programmable control over the behavior of the generative AI model through structured prompt sentences, by computationally integrating a machine-usable expert knowledge base into AI output refinement, and by dynamically tailoring risk and allocation parameters according to real-time user state estimation, thereby reducing processing redundancy, enhancing adaptability, and increasing the technical effectiveness of automated investment strategy generation.

The term “processor” refers to a hardware execution unit, such as a central processing unit or an integrated processing circuit, configured to execute instructions for performing data processing operations described in this specification.

The term “storage device” refers to a non-transitory computer-readable medium, such as a semiconductor memory or magnetic storage, configured to store data, programs, and models used and generated by the processor.

The term “user terminal” refers to an information processing apparatus operated by a user, such as a general-purpose computing device or a mobile computing device, configured to transmit data to and receive data from the server.

The term “external information providing apparatus” refers to a remote information processing system, such as a data distribution server or service platform, configured to provide market-related information via a communication network.

The term “investment transaction history information” refers to data representing one or more past investment transactions, including at least identifiers of financial instruments, transaction dates, transaction types, quantities, prices, and related attributes.

The term “market-related information” refers to data representing conditions of one or more financial markets, including at least price information, index information, exchange rate information, or macroeconomic indicator information.

The term “investment behavior characteristic information” refers to information derived from investment transaction history information and market-related information, representing patterns or tendencies of a user's investment behavior, such as preferred asset classes, typical holding periods, or trading frequency.

The term “risk characteristic information” refers to information derived from investment transaction history information and market-related information, representing a degree or profile of investment risk associated with a user, such as volatility exposure, drawdown tendency, or loss tolerance.

The term “investment target information” refers to information indicating one or more categories or types of investment assets to be included in an investment strategy, such as asset classes, sectors, or regions.

The term “investment allocation information” refers to information indicating allocation ratios or distribution amounts of investment assets within an investment strategy, such as percentage shares assigned to respective asset categories.

The term “investment strategy evaluation information” refers to information representing an evaluation or assessment of one or more investment strategies, including at least investment target information, investment allocation information, and associated performance or risk indicators.

The term “prompt sentence” refers to machine-readable natural language or structured text that instructs a generative AI model to perform a specified processing task, including generating or evaluating investment strategy information.

The term “generative AI model” refers to a trained machine learning model, such as a neural network-based model, configured to generate output data, including natural language text, in response to input data such as a prompt sentence.

The term “investment strategy candidate information” refers to investment strategy-related information generated by the generative AI model in response to a prompt sentence and one or more input features, before correction or refinement by a knowledge base or other post-processing.

The term “knowledge base” refers to a structured data repository stored in the storage device, including at least investment history information and investment policy information of one or more past investment entities, which can be referenced algorithmically by the processor.

The term “investment history information of past investment entities” refers to data representing past investment transactions performed by one or more investors other than the current user, including transaction details and performance outcomes.

The term “investment policy information of past investment entities” refers to data representing explicit or inferred investment principles or rules associated with past investment entities, such as risk preferences, diversification policies, or holding period guidelines.

The term “investment knowledge referenced investment strategy information” refers to investment strategy information obtained by correcting or refining investment strategy candidate information based on information retrieved from the knowledge base.

The term “operation information” refers to data representing user interactions with the user terminal, such as input operations, navigation actions, or configuration changes, which are acquired for estimating a state of the user.

The term “sensor information” refers to data acquired from one or more sensors associated with the user terminal or external devices, such as biometric sensors or motion sensors, for use in estimating a state of the user.

The term “user state information” refers to information representing a state of the user over time, including at least emotional, cognitive, or behavioral aspects estimated based on operation information and sensor information.

The term “emotion state estimation process” refers to processing in which the processor estimates user state information, including emotional aspects, and adjusts one or more parameters of investment strategy candidate information, such as risk levels or asset allocations, in accordance with the estimated user state information.

The term “risk level” refers to an indicator or category representing a magnitude of investment risk associated with an investment strategy, such as a qualitative level or a quantitative measure of risk exposure.

The term “asset allocation” refers to a distribution scheme describing how total investment resources are divided among different asset categories, sectors, or instruments within an investment strategy.

The term “investment strategy information” refers to information representing a finalized or presentation-ready investment strategy, including at least selected investment targets, corresponding allocations, and optionally explanatory text.

The term “investment strategy presentation process” refers to processing in which the processor outputs investment strategy information, obtained after adjustment based on user state information, to the user terminal in a format suitable for display or further interaction.

The term “system utilization transaction information” refers to investment transaction history information that is associated with one or more investment systems, such as pension systems, tax-incentivized systems, or installment-based systems.

The term “contribution-type pension system” refers to an investment system in which an investor periodically contributes funds to a pension account that is invested in one or more financial instruments.

The term “tax-exempt investment system” refers to an investment system in which investment returns are subject to preferential tax treatment, such as tax exemption or tax deferral, under predetermined conditions.

The term “installment investment system” refers to an investment system in which funds are periodically invested in one or more financial instruments according to a predefined schedule.

The term “minor-oriented investment system” refers to an investment system designed to facilitate investments on behalf of individuals who have not reached legal adulthood, subject to specific regulatory or custodial constraints.

The term “investment behavior characteristic information” (in the context of system utilization) refers to information that reflects how a user utilizes different investment systems, including frequency, amount, and type of system utilization, derived from system utilization transaction information.

The term “investment objective information” refers to information representing one or more goals of the user's investments, such as target time horizon, expected return, or purpose of funds.

The term “risk tolerance information” refers to information representing a degree of risk that the user is willing or able to accept in investment activities, expressed as qualitative levels or quantitative thresholds.

The term “constraint condition information” refers to information representing one or more constraints or conditions imposed on the generation of investment strategy candidate information, the constraints being derived from at least investment objective information, risk tolerance information, investment transaction history information, and market-related information.

The term “control of generation of the investment strategy candidate information” refers to influencing or restricting the behavior of the generative AI model by including constraint condition information in the prompt sentence so that the generated investment strategy candidate information satisfies specified conditions.

In one embodiment, the system includes a server, at least one terminal, and a communication network connecting the server and the terminal. The server includes at least one processor, a main memory, a non-transitory storage device, and a network interface. The terminal includes a processor, a memory, a display, one or more input devices, and optionally one or more sensors.

The server executes an operating system such as a UNIX-based or LINUX-based operating system, and application software implemented using, for example, a web application framework such as a Python-based framework. The server further executes a data processing stack including a database management system such as a relational database, a numerical computation library such as a matrix operation library, a data analysis library such as a table-processing library, a machine learning library such as a general-purpose machine learning library, and a natural language processing library such as a transformer-based language model framework. The server additionally accesses a generative AI model, which in one embodiment is implemented as a transformer-based neural network trained on text and tabular descriptions of investment strategies.

The terminal executes a browser application or a dedicated native application, and presents input and output screens to the user. The terminal acquires user operation information via a touch panel, a keyboard, a pointing device, or voice input, and transmits the acquired information to the server via a secure transport protocol. The terminal also acquires sensor information from one or more sensors, such as an accelerometer, a gyroscope, or biometric sensors (for example, a heart-rate sensor or a skin conductance sensor), and transmits the sensor information to the server together with the operation information.

The user operates the terminal to input investment transaction history information. The user specifies information such as financial instrument identifiers, transaction dates, transaction types (purchase or sale), transaction quantities, transaction prices, fees, and account identifiers. The terminal performs initial validation, such as format checking and data type checking, and converts the input into structured records. The terminal then transmits these records to the server.

The server receives the investment transaction history information and stores it in the storage device as normalized records. In one embodiment, the server represents each transaction as a row in a table having fields such as a user identifier, an instrument identifier, a transaction timestamp, a transaction side flag, a quantity, a price, and a fee. The server maintains indices over at least the user identifier, the instrument identifier, and the transaction timestamp to reduce query latency for subsequent analysis. The server thereby creates an internal data structure optimized for joining with market-related information and for computing derived quantities such as position size and realized profit and loss.

The server acquires market-related information from an external information providing apparatus via an application programming interface. The server periodically sends requests to external servers that maintain financial time series. The server receives responses containing fields such as opening price, closing price, highest price, lowest price, trading volume, and optionally index values and macroeconomic indicators. The server converts time stamps to a unified time zone, normalizes currency units to a reference currency, and stores records into structured tables, for example, a “prices” table and an “indicators” table. The server uses bulk insert operations and columnar indices to enable efficient range queries over time and across instruments.

The server processes the investment transaction history information and the market-related information using the data analysis library. The server loads the relevant records into in-memory tabular objects. The server constructs per-user time series of portfolio holdings by computing cumulative quantities per instrument over time. The server joins the portfolio holdings with market price time series to compute derived metrics, such as daily portfolio value, return series, volatility measures, and drawdowns. The server then aggregates these metrics according to predetermined time windows and grouping keys (for example, by asset class or by sector) to generate investment behavior characteristic information and risk characteristic information.

The server represents the investment behavior characteristic information and the risk characteristic information as structured feature vectors and summary descriptors. In one embodiment, the server constructs a fixed-length feature vector for each user, where each dimension corresponds to a statistic such as average holding period, maximum drawdown, standard deviation of daily returns, percentage of transactions in particular asset categories, or leverage usage. The server stores these feature vectors in a dedicated feature store. The server also generates human-readable descriptors such as “high concentration in growth equities” or “frequent short-term trades,” which are used later in prompt construction.

The server applies machine learning algorithms from the machine learning library to further analyze the behavior and risk features. For example, the server uses a clustering algorithm to assign the user to one of several behavior clusters, such as “long-term diversified,” “short-term speculative,” or “income-oriented.” The server uses a supervised or semi-supervised classification algorithm to derive a risk level label, such as conservative, moderate, or aggressive, based on thresholds learned from historical user performance data. The server thereby transforms raw transactional records into higher-level, machine-understandable representations.

The server additionally maintains a knowledge base in the storage device, containing investment history information and investment policy information of past investment entities. The server represents such information as structured records, for example, sequences of historical positions and accompanying policy tags such as “value-oriented,” “momentum-oriented,” or “capital preservation.” The server also stores performance metrics for these entities. The server indexes this knowledge base by feature vectors similar to the behavior and risk feature vectors described above.

The server uses the knowledge base to correct or refine investment strategy candidate information later generated by the generative AI model. For example, the server retrieves records of past entities whose feature vectors are within a predetermined distance of the current user's feature vector in a high-dimensional feature space. The server computes aggregate policies or constraints observed to be effective for these similar entities, such as typical maximum allocation to a single sector or typical hedge ratio. The server uses these aggregates as signals to adjust or bound the output from the generative AI model. This non-conventional use of a structured, feature-indexed knowledge base allows the server to algorithmically adjust AI outputs in a way that improves stability and reduces extreme or inconsistent strategies.

The server constructs a prompt sentence for the generative AI model based on the investment behavior characteristic information, the risk characteristic information, the market-related information, and the user's explicit request. The user enters a natural language request at the terminal, such as:
“Using my investment history from the past 5 years, generate an investment strategy for the next 6 months with medium risk.”

The terminal transmits this request text to the server. The server parses the text to extract explicit parameters such as the time horizon and the risk level. The server then composes an extended prompt sentence that includes: a description of the user's historical behavior, a summary of current market conditions, explicit risk and horizon constraints, and directions about the format of the output. An example extended prompt sentence is:
“The user has mainly invested in large-cap growth equities over the past 5 years, with an annualized return of approximately 7.5% and a maximum drawdown of approximately 18%. Current market conditions show rising interest rates and moderate volatility in major equity indices. The user requests: ‘Using my investment history from the past 5 years, generate an investment strategy for the next 6 months with medium risk.’ Based on the user's investment behavior characteristics and risk characteristics, and based on the current market environment, propose a diversified investment strategy that uses medium risk, specifies allocation percentages for major asset categories, provides example instrument types for each category, and explains the rationale in clear language. The strategy should limit expected maximum drawdown to approximately 15% and avoid excessive concentration in any single sector.”

The server converts quantitative feature values and market statistics into numerical phrases in the prompt sentence in a consistent template. The server utilizes this templating to achieve more predictable behavior from the generative AI model and to reduce variability due to ambiguous instructions. This structured prompt construction is a non-conventional mechanism that improves the computer's ability to control the generative AI model, leading to higher precision and reduced need for manual post-editing.

The server executes a generative AI model, which in one embodiment is a transformer-based neural network with multiple self-attention layers, feedforward layers, and layer normalization layers. The server uses a dedicated inference engine, which may run on a graphics processing unit (GPU) or a specialized accelerator. The generative AI model has been pre-trained on a large corpus of text and fine-tuned on domain-specific investment texts. During training, the server (or a training apparatus) uses a sequence-to-sequence objective with a cross-entropy loss function and an optimizer such as an adaptive gradient method. The training data is augmented by synthetic variations of investment strategy descriptions to improve robustness.

The server, during inference, tokenizes the prompt sentence into subword tokens, embeds the tokens into vector representations, and performs forward propagation through the transformer layers. The self-attention mechanism computes attention weights based on scaled dot products between query, key, and value vectors. The feedforward network applies non-linear transformations to each token representation. The final layer outputs a probability distribution over vocabulary tokens for each position, and the server decodes a sequence of tokens using a sampling method such as top-k sampling or nucleus sampling, with a temperature parameter chosen to balance creativity and determinism. The server then converts the token sequence into a natural language investment strategy candidate.

The server does not merely let the generative AI model “decide” in an abstract way; instead, the server constrains and shapes the model's output via the structured prompt sentence and via post-processing rules. The server applies rule-based filters and numerical checks on the generated allocation percentages and risk descriptors, verifying, for example, that allocation percentages sum to 100% within an allowed tolerance and that suggested leverage or derivative usage does not exceed a threshold. The server uses the knowledge base to compare the candidate strategy with historical policies of similar entities and to dampen extreme deviations. In one variant, the server uses a separate scoring model, trained using supervised learning on labeled strategy examples, to assign an internal quality score to the candidate strategies and to select or modify only those strategies that exceed a score threshold.

The server estimates user state information using operation information and sensor information. The terminal collects temporal patterns of user operations, such as response time, frequency of switching between screens, and intensity of interactions, and collects physiological signals if available. The server aggregates these data into short time windows and computes features such as variance of operation intervals, changes in scrolling speed, or fluctuations in heart rate. The server applies a machine learning model, such as a recurrent neural network or a temporal convolutional network, to classify these features into user state categories, for example, calm, stressed, or uncertain.

The server then adjusts the risk level and allocation of the investment strategy candidate based on the estimated user state. For instance, when the user state is classified as stressed, the server reduces the proportion of high-volatility assets and increases the proportion of lower-volatility assets or cash-like instruments. The server performs this adjustment via deterministic algorithms that apply scaling factors to risk-related allocation parameters. The server, for example, multiplies exposure to high-beta assets by a factor less than one and redistributes the freed allocation across defensive categories. This process reduces the likelihood of presenting strategies that could exacerbate user anxiety and provides a technical mechanism for state-aware control of investment strategy generation.

The server outputs the final investment strategy information to the terminal. The terminal receives the structured data and renders it as text, tables, and optionally charts. The terminal highlights key parameters such as target allocations, expected risk range, and recommended holding period. The terminal may also present an explanation section, generated by the generative AI model but filtered by the server, which describes the rationale for the strategy in non-technical terms for the user's understanding.

This configuration and processing flow improve computer technology in several respects. The server uses unified feature structures and a knowledge base indexed by feature vectors to reduce redundant computations and to enable fast similarity retrieval, thereby improving processing speed and scalability. The server uses structured prompt construction and algorithmic constraints to stabilize and control a generative AI model, reducing variance in outputs and lowering the need for human intervention, which improves the efficiency and reliability of the overall computing system. The server integrates user state estimation based on temporal operation patterns and sensor signals, which is not a conventional business logic addition but a specific technical feature that alters the computer's internal decision process, resulting in adaptive, state-aware resource allocation in the generation module.

In another embodiment, the server employs alternative neural architectures, such as a hybrid model that combines a transformer encoder for processing structured financial features and a transformer decoder for generating natural language recommendations. The server may also use alternative loss functions during training, such as a combination of cross-entropy loss for language quality and a mean-squared error term for matching target risk metrics, enabling the model to better align generated strategies with numerical constraints. The server can also utilize data augmentation techniques, such as random perturbations of historical return series and synthetic policy combinations, to improve robustness against market regime shifts.

In yet another embodiment, the server does not rely solely on a single generative AI model. The server may orchestrate multiple models, for example, a first model optimized for allocation suggestions and a second model optimized for textual explanation. The server then merges outputs from these models in a post-processing module, which runs deterministic algorithms to ensure consistency between numerical allocations and narrative explanations. This multi-model configuration further enhances correctness and clarity of the system's output while maintaining computational efficiency through parallel processing on the server hardware.

The terminal may vary in configuration. In one variation, the terminal is a mobile device with limited computational resources, and the server performs substantially all heavy computations, including feature extraction, model inference, and knowledge base retrieval. In another variation, the terminal performs preliminary data aggregation or local caching to reduce communication load and to allow limited offline operation. In either case, the distribution of computation between the server and the terminal is designed such that network bandwidth usage is minimized and latency-sensitive tasks, such as user state feedback, receive priority handling.

The user can use the system not only for long-term strategy generation but also for periodic updates. The user may transmit modified prompt sentences such as: “Adjust the previous strategy to be more conservative and limit potential drawdown to around 10%.”

The server interprets these subsequent prompts and updates the constraint condition information accordingly. The server does not fully recompute all features from scratch; rather, the server reuses cached behavior and risk feature vectors and only recomputes the parts affected by new market data or new constraints. This incremental recomputation design reduces server load and improves response time, demonstrating a specific technical optimization of data management and computation scheduling.

Through these configurations and variations, the server, the terminal, and the communication mechanisms cooperate to provide a concrete, technically-implemented system that performs specialized data transformations, AI model orchestration, and real-time user state integration, resulting in improved computational performance, enhanced strategy quality, and reduced communication and processing overhead compared with conventional systems that rely on static rules or uncontrolled generative models.

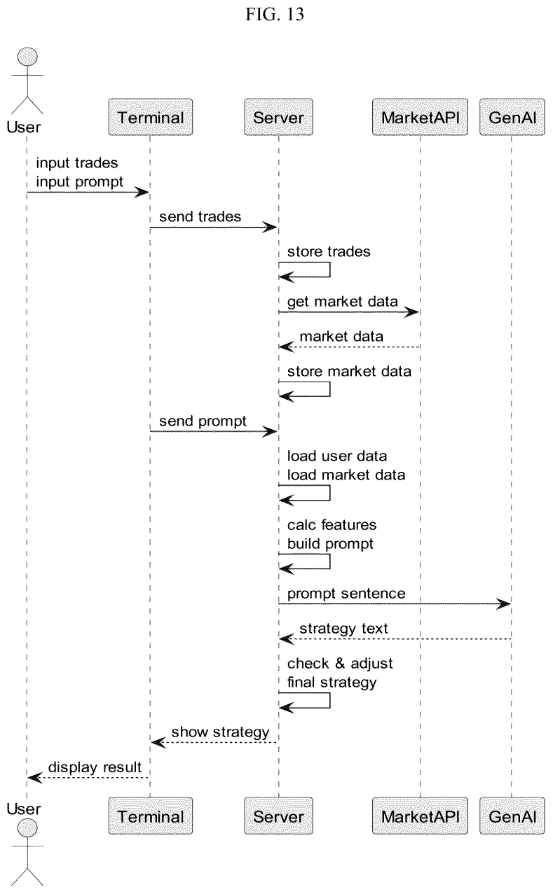

The following describes the processing flow using FIG. 13.

### Step 1:

The user operates the terminal to start an application and open an input screen for investment transactions.
The terminal receives input from the user including instrument identifiers, transaction dates, transaction types, quantities, prices, and fees as input data.
The terminal performs format checking and type validation on the input data, converts the data into structured records, and outputs validated transaction records.

### Step 2:

The terminal transmits the validated transaction records as a request message to the server via a communication network.
The server receives the request message as input, parses the message, and extracts user identifiers and transaction fields.
The server normalizes the extracted fields into a tabular data structure and outputs normalized investment transaction history records.

### Step 3:

The server stores the normalized investment transaction history records into a storage device as rows of a transaction table.
The server uses the normalized records as input, assigns primary keys, and creates or updates indices on user identifiers, instrument identifiers, and timestamps.
The server outputs persistent transaction records and updated index metadata in the storage device.

### Step 4:

The server periodically transmits market data requests to an external information providing apparatus.
The external apparatus returns market-related information such as price series and index values as input to the server.
The server converts time zones, normalizes currency units, checks for missing or erroneous values, and outputs cleaned market-related records stored in market data tables.

### Step 5:

The server receives a strategy request from the terminal that includes a prompt sentence provided by the user, such as “Using my investment history from the past 5 years, generate an investment strategy for the next 6 months with medium risk.”
The server uses the prompt sentence and the user identifier as input, parses the prompt to extract explicit constraints such as horizon and risk level, and outputs parsed constraint parameters.

### Step 6:

The server retrieves investment transaction history records for the user from the storage device using the user identifier as input.
The server loads the retrieved records into an in-memory tabular object, groups the records by instrument identifier, and sorts them by transaction timestamp.
The server outputs ordered transaction series per instrument.

### Step 7:

The server retrieves market-related records for instruments appearing in the ordered transaction series.
The server uses the ordered transaction series and the market-related records as input, joins these datasets on instrument identifiers and timestamps, and computes position sizes, portfolio values, returns, and realized profit and loss.
The server outputs time series of portfolio metrics for the user.

### Step 8:

The server uses the portfolio metric time series as input and calculates aggregated statistics such as average holding period, volatility, maximum drawdown, sector allocation ratios, and trade frequency.
The server constructs a fixed-length feature vector where each element corresponds to a computed statistic, and outputs the feature vector as investment behavior characteristic information.

### Step 9:

The server uses the portfolio metric time series and the feature vector as input and derives risk-related measures such as downside deviation, loss frequency, and exposure to high-volatility instruments.
The server applies predefined thresholds and classification logic to these measures and outputs a risk characteristic label and associated numerical risk profile values as risk characteristic information.

### Step 10:

The server applies a machine learning algorithm, such as clustering, to the investment behavior characteristic information as input to categorize the user into a behavior cluster.
The server computes distances between the user's feature vector and cluster centroids, assigns the closest cluster, and outputs a cluster identifier and cluster-level descriptors.

### Step 11:

The server accesses a knowledge base stored in the storage device and retrieves feature vectors and policy descriptors of past investment entities.
The server uses the user's feature vector as input and performs similarity search in the feature space to identify similar entities.
The server aggregates policies and risk constraints from the similar entities and outputs aggregated knowledge signals such as typical maximum sector allocations and hedge ratios.

### Step 12:

The server constructs an extended prompt sentence by combining the original prompt sentence, the investment behavior characteristic information, the risk characteristic information, the cluster descriptors, the aggregated knowledge signals, and a summary of current market-related information.
The server formats numeric values into textual descriptions and embeds them into a template, using all these components as input, and outputs a structured extended prompt sentence for the generative AI model.

### Step 13:

The server tokenizes the extended prompt sentence into subword tokens and embeds the tokens into numeric vectors as input to a generative AI model implemented as a transformer-based neural network.
The server performs forward propagation through attention layers and feedforward layers based on model parameters stored in the storage device and computes probability distributions over vocabulary tokens at output positions.
The server decodes these probability distributions into a sequence of tokens using a sampling strategy and outputs a generated text sequence as investment strategy candidate information.

### Step 14:

The server parses the generated investment strategy candidate information into structured elements such as asset categories, allocation percentages, risk descriptions, and explanatory text.
The server uses the parsed structure as input and checks for numerical consistency, ensuring that allocation percentages sum to approximately 100% and that leverage or risk bounds do not violate system constraints.
The server outputs a normalized and internally consistent investment strategy candidate record.

### Step 15:

The server uses the normalized investment strategy candidate record and the aggregated knowledge signals as input and compares suggested allocations and constraints with historical patterns from similar entities.
The server adjusts allocations that exceed typical bounds by scaling them down and redistributing excess allocation to safer categories, and modifies risk descriptors if necessary.
The server outputs corrected investment knowledge referenced investment strategy information.

### Step 16:

The terminal collects operation information from the user, such as interaction speed, navigation patterns, and input timing, and collects sensor information such as motion data or biometric data when available.
The terminal sends the operation information and sensor information as input to the server.
The server aggregates these signals into temporal windows and outputs feature vectors representing user interaction and physiological patterns as candidate user state information.

### Step 17:

The server applies a user state estimation model, such as a recurrent neural network or temporal classifier, to the candidate user state information as input.
The server computes classification scores for states such as calm, stressed, or uncertain, selects the state with the highest score, and outputs user state information including a state label and confidence values.

### Step 18:

The server uses the user state information and the corrected investment knowledge referenced investment strategy information as input and determines adjustment factors for risk level and asset allocation.
The server scales exposure to high-risk asset categories downward when the user state indicates stress, and scales exposure upward within limits when the user state indicates calmness, while preserving overall allocation constraints.
The server outputs a state-adjusted investment strategy record as final investment strategy information.

### Step 19:

The server formats the final investment strategy information into a response message containing structured allocation tables and explanatory text.
The server sends the response message as output to the terminal over the communication network.
The terminal receives the response message as input, parses the message, and renders the investment strategy on the display using textual elements, tables, and optional graphical elements, and outputs the displayed content to the user.

### Step 20:

The user reviews the displayed investment strategy and may decide to refine the request.
The user inputs an additional prompt sentence at the terminal, such as “Adjust the strategy to be more conservative and limit potential drawdown to around 10%.”
The terminal sends the new prompt sentence and context identifiers as input to the server, and the server treats this input as a new strategy request, reusing stored feature vectors and recomputing only the affected processing, thereby outputting an updated investment strategy in subsequent iterations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented investment advisory systems primarily focus on numerical optimization of portfolios based on static financial parameters such as expected return, volatility, and diversification. In such systems, a processor typically executes a fixed algorithm or a predetermined rule set to generate recommendations, and then simply renders the resulting asset allocation on a user interface. These systems exhibit several technical limitations.

First, conventional systems do not dynamically integrate heterogeneous data streams in a coordinated computational pipeline. In particular, financial account data, market data, and user-related context signals such as emotional state are processed, if at all, in separate subsystems without a unified feature representation. As a result, the processor cannot adapt its internal models in real time to changes in both market conditions and user state, leading to suboptimal utilization of computing resources and fragmented data flow.

Second, existing systems that use machine learning models generally expose only raw numerical outputs (for example, allocation vectors or risk scores) to a presentation layer. The transformation of these numerical outputs into user-facing explanations is often handled by static templates or manually crafted text. This separation introduces an additional application layer that must be maintained separately and that frequently becomes a bottleneck, because any change in the underlying models requires manual changes in the explanation logic.

Consequently, the overall system is not scalable or maintainable from a software-architecture standpoint.

Third, even where natural language generation techniques are introduced, generative models are often invoked with simplistic input text that does not convey the full context of the machine learning outputs, user attributes, market state, and emotional state in a structured manner. Because the prompt sentences are not systematically constructed from the internal system state, the generative models cannot consistently produce accurate or context-appropriate advisory content. This leads to unstable system behavior, where the same underlying numerical result may produce inconsistent explanations, thereby degrading system reliability and predictability.

Fourth, conventional emotion-aware systems, if present, typically treat emotion as a superficial display parameter (for example, changing colors or icons) rather than as a first-class computational input to the investment strategy engine. In such architectures, emotion data is processed in an isolated module and is not formally integrated with model outputs, user profiles, and market data within the processor's decision pipeline. This prevents the system from performing systematic, algorithmic adjustment of portfolio recommendations based on real-time emotional signals, and limits the ability to optimize system performance against user behavior over time.

Fifth, existing systems rarely exploit generative AI models as an internal control component in the strategy pipeline. In particular, they do not use generative AI models as programmable language-based “orchestrators” driven by machine-generated prompt sentences. Without a processor that programmatically constructs prompt sentences from structured data, the system cannot leverage generative models to generate coherent, consistent explanations and higher-level strategies in a closed loop using internal state. This limits the extent to which the system can automate the conversion of low-level model outputs into high-level domain reasoning.

Accordingly, there is a need for an improved computer-implemented system in which the processor (i) unifies financial data, market data, and emotion data into a common processing pipeline, (ii) uses machine learning models to compute asset strategies while algorithmically adjusting them according to real-time emotional state, (iii) programmatically generates context-rich prompt sentences for a generative AI model based on internal numerical outputs and user context, and (iv) uses the responses of the generative AI model as integrated components of the strategy-generation and feedback loop. Such a system would improve the operation of the computer itself by providing a more efficient data flow, a more modular division of computation between numerical and generative models, and a more robust, automatically maintainable explanation mechanism.

The specific processing by the specific processing unit 290 of the data processing device 12 in Application Example 2 is realized by the following means.

The present invention provides a server comprising a processor and a memory storing instructions which, when executed by the processor, cause the processor to perform operations including: acquiring, from one or more external information sources, financial account data, transaction data, and market data, and preprocessing the data using a database management component and a data analysis software component to generate feature data; executing a machine learning model on the feature data to calculate numerical outputs representing asset management strategies, future asset trends, and goal achievement probabilities; acquiring user context signals including user attribute information and real-time emotion information, estimating an emotional state using an emotion recognition model, and recording the estimated emotional state as emotional state history; algorithmically integrating the numerical outputs, the user attribute information, and the emotional state history to generate an adjusted asset management strategy in which asset allocation ratios, risk levels, and management policies are modified according to the emotional state; programmatically constructing a prompt sentence that encodes the adjusted asset management strategy, the user's current asset situation, and summary market information, and that instructs a generative AI model to generate, in natural language, a detailed explanation of the adjusted asset management strategy and its rationale; invoking the generative AI model with the prompt sentence to obtain an explanation text, and using the explanation text as proposal information coupled with the adjusted asset management strategy; and controlling a user interface on a user terminal and, when necessary, an electronic settlement apparatus or a transaction execution apparatus, based on the adjusted asset management strategy and the proposal information, and updating the database management component with execution results. This enables the computer system to internally coordinate numerical machine learning models and generative AI models through automatically generated prompt sentences, to dynamically adapt investment strategies in response to real-time emotional state and evolving data streams, and to produce consistent, context-aware natural language outputs as part of a unified computational pipeline, thereby improving the efficiency, scalability, and reliability of the underlying computer-based investment advisory platform.

The term “processor” refers to a hardware computation unit or a combination of hardware and firmware configured to execute program instructions and perform arithmetic, logical, control, and data-processing operations for implementing the functions of the system.

The term “memory” refers to a non-transitory computer-readable storage medium configured to store program instructions and data used by the processor, including volatile and non-volatile storage devices.

The term “database management component” refers to a software and/or hardware module configured to store, organize, query, and update structured data in persistent storage, such as financial data, market data, and emotion data.

The term “data analysis software component” refers to a software module configured to preprocess, transform, and analyze numerical and categorical data, including operations such as cleaning, normalization, aggregation, and feature extraction.

The term “financial account data” refers to digital information indicating balances, positions, and related attributes associated with one or more financial accounts maintained for a user.

The term “transaction data” refers to digital records of executed financial operations, including purchases, sales, transfers, and other asset-related events associated with a user.

The term “market data” refers to digital information representing conditions of a financial market, including prices, volumes, indices, volatility measures, and other market indicators.

The term “feature data” refers to numerical or categorical data structures derived from raw input data through preprocessing and feature extraction, suitable for input to a machine learning model.

The term “machine learning model” refers to a computational model trained using a machine learning algorithm to map input data to output predictions or classifications, such as asset trends, risk scores, or recommended allocations.

The term “generative AI model” refers to an artificial intelligence model configured to generate natural language or other content based on input text or other conditioning information, including large-scale language models.

The term “prompt sentence” refers to a machine-generated or programmatically constructed text input that instructs a generative AI model to perform a specific task, and that encodes structured information such as user attributes, numerical outputs, and context.

The term “user attribute information” refers to data describing characteristics of a user, including age, investment objectives, risk tolerance, time horizon, and other profile parameters.

The term “investment objective” refers to a target or goal that a user intends to achieve through asset management, such as a target asset amount, growth rate, or time-based financial goal.

The term “risk tolerance” refers to a quantitative or qualitative measure of the level of investment risk that a user is willing to accept in pursuit of an investment objective.

The term “asset management method” refers to a strategy or scheme for allocating and managing financial assets across one or more asset classes or instruments.

The term “asset management strategy” refers to a set of rules, allocations, and policies defining how a user's assets should be distributed and adjusted over time to achieve specified objectives.

The term “numerical output” refers to data produced by a computation or model in a quantitative form, such as vectors, scores, probabilities, or allocation ratios, prior to any natural language conversion.

The term “future asset trend” refers to a predicted evolution of a user's asset value or composition over time as estimated by a machine learning model.

The term “goal achievement probability” refers to a numerical value representing a likelihood that a user's asset-related objective will be reached within a specified time horizon.

The term “context signal” refers to dynamic information related to a user or environment, including emotional state, behavior, or market conditions, which can be used to adapt system behavior.

The term “emotional state” refers to a condition of a user's affect or mood, such as stress, relaxation, joy, or sadness, estimated from sensor data or other indicators.

The term “emotion recognition model” refers to a computational model configured to estimate a user's emotional state based on input data such as facial expressions, voice characteristics, or biometric signals.

The term “emotional state history” refers to a time-series record of estimated emotional states of a user, stored for later analysis and use in strategy adjustment.

The term “facial expression information” refers to digital data representing a user's face, including images or extracted features, suitable for inferring emotional state.

The term “voice information” refers to digital audio signals or derived features representing a user's speech characteristics, usable for emotion estimation.

The term “biometric information” refers to physiological or behavioral signals, such as heart rate, skin conductance, or motion patterns, that can be processed to infer emotional or physical state.

The term “image acquisition apparatus” refers to a hardware device configured to capture visual data, such as a digital camera or image sensor.

The term “voice acquisition apparatus” refers to a hardware device configured to capture audio data, such as a microphone.

The term “biometric information acquisition apparatus” refers to a hardware device configured to measure biometric signals, such as a wearable sensor or physiological monitoring device.

The term “adjusted asset management strategy” refers to an asset management strategy that has been modified from an initial strategy by taking into account additional factors such as emotional state, user attributes, or updated data.

The term “asset allocation ratio” refers to a numerical proportion that specifies a distribution of a user's total assets among different asset categories or instruments.

The term “risk level” refers to a quantitative or qualitative indicator of the overall risk associated with an asset management strategy or portfolio.

The term “management policy” refers to a set of conditions or rules that govern how an asset management strategy should respond to changes in user state, market conditions, or other inputs.

The term “explanation data” refers to structured information, including strategy parameters, user asset status, and market summaries, used to generate a natural language explanation via a generative AI model.

The term “explanation text” refers to natural language output produced by a generative AI model that describes and justifies an asset management strategy or related recommendation.

The term “proposal information” refers to a combination of explanation text and associated strategy parameters presented to a user as a recommendation or advice.

The term “user terminal” refers to an electronic device operated by a user, such as a smartphone, tablet, or computer, configured to display information and accept user inputs.

The term “display control” refers to operations performed by the system to determine and render content on a user terminal screen according to internal data and logic.

The term “notification control” refers to operations performed by the system to generate and transmit alerts or messages to a user terminal, including push notifications or in-application messages.

The term “electronic settlement apparatus” refers to a system or service configured to perform electronic payment, transfer, or settlement of funds according to instructions from the server.

The term “transaction execution apparatus” refers to a system or service configured to place and execute financial orders or trades on behalf of a user.

The term “execution result” refers to data indicating the outcome of a requested financial transaction, including success status, quantities filled, prices, and timestamps.

The term “public information source” refers to an information provider accessible via a communication network, supplying data such as historical investment results or market analyses.

The term “external information providing apparatus” refers to a system that delivers data to the server via an interface, including but not limited to financial data feeds and analytic services.

The term “investment performance data” refers to historical records describing outcomes of investment activities, including returns, volatility, and benchmark comparisons.

The term “market analysis data” refers to analytical outputs derived from market data, including indicators, factor analyses, and summary statistics.

The term “past successful case” refers to a historical investment scenario in which a specified objective was achieved under particular market and risk conditions.

The term “report format” refers to an organized structure for presenting information, such as a textual summary or multi-section document, suitable for human reading.

In one embodiment, a server includes a processor, a memory, a network interface, and a storage device. The server executes program modules implemented, for example, in a general-purpose programming language such as Python, running on an operating system such as a server operating system. The server communicates with one or more terminals operated by users over a communication network. The terminal includes a processor, a display, an input device, a camera, a microphone, and optionally one or more biometric sensors such as a heart-rate sensor in a wearable device. The terminal executes a client application implemented, for example, using a cross-platform application framework or a web browser with a script engine.

The server stores, in the storage device, a database management component configured, for example, as a relational database system such as a structured query engine (for example, MySQL, SQLite), and a set of data tables including a user profile table, an account table, a holdings table, a transaction table, a market data table, and an emotion state table. The server also stores a data analysis software component including a numerical library (for example, a matrix computation library such as NumPy) and a data-frame library (for example, a tabular data library such as Pandas). These software components enable the server to perform vectorized operations, normalization, and feature extraction in main memory, thereby reducing disk I/O and improving throughput compared to line-by-line processing.

The server further stores one or more machine learning models for numerical computation, for example implemented using a deep learning framework such as TensorFlow or PyTorch. In one example, the server uses a multi-layer neural network having an input layer, several hidden layers, and an output layer. The input layer receives a feature vector formed from user-level and market-level features; the hidden layers are composed of fully connected units with non-linear activation functions such as rectified linear units; and the output layer produces continuous outputs representing predicted returns, risk scores, and goal achievement probabilities. The server also stores an emotion recognition model, which may be a convolutional neural network for image-based emotion recognition or a recurrent neural network for audio-based emotion recognition. The server additionally accesses a generative AI model, for example a transformer-based language model provided as a remote service, by sending a prompt sentence and receiving a natural language response.

The terminal executes a client-side emotion sensing module. The terminal captures facial expression information using the camera and captures voice information using the microphone. The terminal optionally receives biometric information from a connected wearable device via a short-range wireless communication protocol. The terminal can perform local pre-processing such as face detection using a computer vision library (for example, a library comparable to OpenCV), audio feature extraction (for example, mel-frequency cepstral coefficient extraction), and basic filtering of biometric time series. The terminal converts these raw signals into numerical feature vectors and transmits them to the server, or, in an alternative embodiment, locally runs an emotion recognition library (for example, an embedded emotion analysis SDK) to output emotion labels such as “stress,” “relaxed,” “joy,” and “sadness” together with confidence scores, and transmits only the labels to the server. By offloading heavy neural network inference to the server, the system reduces computation on the terminal and improves battery life, while still exploiting local pre-processing to compress data and reduce network bandwidth.

The server acquires financial account data and transaction data from external information providing apparatuses such as banking systems or brokerage systems. The server uses a network interface and an HTTP client library (for example, a generic request library) to call external application programming interfaces and receive response payloads formatted in a structured data format. The server validates these payloads, normalizes currency and timestamp fields, and writes the normalized records into database tables. The server also periodically acquires market data, including price series for assets, index values, and volatility measures, from one or more market data feeds. The server thereby maintains a time-aligned data store that combines user-specific transaction data with global market data, allowing efficient joining and feature computation using indexed SQL queries and vectorized operations in the data analysis component.

The server executes a feature generation pipeline. The server loads, from the database management component, all records related to a given user: user profile, historical holdings, transaction history, and corresponding market data. The server uses the data analysis software component to construct, for each time point, a feature vector containing elements such as: current portfolio weights per asset class; realized volatility over past windows; maximum drawdown; trading frequency; sector diversification; and ratios indicating exposure to specific asset types. At the same time, the server computes market-level features such as moving averages, price momentum, correlation coefficients between asset classes, and risk factor indicators. The server concatenates these elements into a single multi-dimensional array with a fixed ordering and dimension, ensuring compatibility with the input layer of the machine learning model.

The server trains the machine learning model in an offline mode before deployment. The server gathers historical training data for many users, including their past portfolios, market contexts, and subsequent realized performance. The server defines a loss function, for example a weighted sum of squared error between predicted and actual returns and a cross-entropy term for classification tasks such as hit-or-miss goal achievement within a timeframe. The server initializes model parameters and performs gradient-based optimization, for example using a stochastic gradient descent variant, with mini-batches of training samples. The server applies regularization techniques such as dropout or weight decay to reduce overfitting, and uses data augmentation, such as random time-window shifts or noise injection in inputs, to improve robustness. During training, the server monitors validation error and uses early stopping criteria. When training converges, the server stores the learned weights as a model file in persistent storage.

The server loads the trained model into memory during runtime. When new feature vectors are generated for an active user, the server performs a forward pass through the neural network using a numerical computation backend (for example, a tensor computation engine). The server receives outputs such as predicted annualized return, predicted portfolio volatility, and probability that the user will reach a predefined goal within a specified horizon. These outputs are numerical and are stored temporarily in memory as an intermediate representation. By computing these predictions using an optimized tensor backend, the server achieves lower latency and higher throughput than would be possible with hand-coded rule systems operating on scalar values.

The server executes an emotion recognition pipeline. In one configuration, the server receives images of the user's face taken by the terminal camera and preprocessed as normalized, grayscale or color images at a fixed resolution. The server feeds these images into a convolutional neural network trained on annotated emotion datasets. The convolutional neural network includes multiple convolutional layers, pooling layers, and fully connected layers, and outputs a probability distribution over predefined emotion categories. The server also optionally receives voice features or biometric features and combines them through a late-fusion layer that aggregates probabilities or scores. The server stores the most probable emotion label along with its confidence and a timestamp in the emotion state table. In another configuration, where emotion labels are computed locally on the terminal, the server simply records the provided labels and confidence values without re-computing them.

The server uses the emotion state history, together with user attributes and numerical outputs of the asset management model, to construct an adjusted asset management strategy. The server implements a strategy adjustment module that applies non-trivial rules and optimization steps rather than merely re-scaling weights. For example, the server defines a risk adjustment function that maps a base risk level and an emotion severity score to a target risk level. If the emotion state is “stress” with high confidence, the server reduces the target risk level according to a pre-defined non-linear function. The server then solves a constrained optimization problem: minimize the distance between the base allocation vector and a new allocation vector under constraints that the new vector respects the adjusted risk level and investment policy constraints (such as minimum cash reserves, prohibition of certain asset categories, or diversification requirements). The server may solve this optimization using a quadratic programming solver or a gradient-based method operating on the allocation vector. This process yields an adjusted asset allocation ratio for each asset class. By combining numerical optimization with emotion-based constraints, the server enforces a repeatable, algorithmic transformation that is not easily performed by manual human judgment in real time.

The server constructs prompt sentences for the generative AI model using internal data objects instead of ad-hoc human-authored text. The server stores, in memory, an object containing: the adjusted asset management strategy, including allocation ratios and risk indicators; the user's current asset situation, including total asset amount and breakdown by category; a summary of the current market environment, such as volatility regimes or sector trends; and a summary of the emotion state history, such as the most recent emotion and its duration. The server uses a template-based generator or a small natural language processing module (for example, token concatenation functions) to programmatically map these structured fields into a textual prompt sentence with labeled sections. For example, the server may generate a prompt sentence such as:
“Based on the following data, propose a concrete, step-by-step investment strategy in plain English.
User profile: 40 years old, medium risk tolerance, wants to double assets in 5 years.
Current assets: 3,000,000 yen diversified in domestic stocks and bonds.
Model output: to achieve the goal, a portfolio with 60% global equities, 30% bonds, and 10% cash is recommended.
Emotion state: stress is detected, so please propose a safer variant of the above strategy and explain why it still supports the user's goal.
Current market: high volatility in technology stocks, relatively stable bond yields.
Please output clear recommendations, including example asset classes and risk explanations.”

In another example, the server generates a prompt sentence:
“The user's current assets are 950,000 yen and the goal is 1,000,000 yen. Analyze the user's asset situation and propose an optimal investment strategy to safely reach the remaining 50,000 yen, considering that the user's emotion state is stress.”

In another example, the server generates a prompt sentence:
“When the user's emotion state is stress, please propose a stable, low-risk investment strategy and explain it in easy-to-understand language.”

The server transmits the prompt sentence to a generative AI model endpoint via the network interface. The generative AI model is, for example, a transformer-based large language model hosted on an external computation infrastructure. The server specifies generation parameters such as maximum output length and randomness settings. The server receives, as a response, an explanation text describing the adjusted asset management strategy, including detailed recommendations and rationales. The server may parse structural cues in the explanation, such as bullet points or section headings, and map them back into internal objects for use in other modules. By using structured prompt construction based on numerical model outputs and system state, the server provides the generative AI model with a richer, machine-consistent context, which leads to more stable and predictable outputs than free-form prompts would produce.

The terminal receives the explanation text and the adjusted asset management strategy. The terminal renders these as user interface elements such as charts, lists, and explanatory paragraphs. The terminal may display a pie chart illustrating the new allocation ratios, a line chart showing projected asset growth under the adjusted strategy, and text explaining how recent emotional states influenced the recommendation. By structuring the explanation, the terminal improves user comprehension and reduces the risk of misinterpretation of advice. The user interacts with the explanation via the terminal. The user may, for example, select an option to request a safer or more aggressive variant of the proposed strategy. When the user requests a safer strategy, the terminal sends a new request to the server, indicating the desired direction. The server then re-applies its adjustment and optimization processes: it tightens risk constraints, recomputes allocation ratios, and generates a new prompt sentence for the generative AI model. The generative AI model returns an updated explanation, and the server updates the terminal display. This iterative loop allows the system to converge quickly to a user-acceptable strategy with minimal user input, while most of the computation and text generation occurs automatically in a structured, machine-driven manner.

The server can also connect to an electronic settlement apparatus or a transaction execution apparatus to carry out asset transfers or trades corresponding to the adjusted asset management strategy. Once the user approves a strategy on the terminal, the server computes order quantities based on the user's available balances and the target allocation ratios. The server then constructs order messages in the format required by an external trading interface, signs or authenticates the requests as required, and transmits them over the network. Upon receiving execution reports, the server updates its database tables with new transaction records and refreshed holdings. By tightly integrating transaction execution within the same computational pipeline that generates and explains strategies, the system reduces latency between decision and execution and ensures that database state remains consistent with actual asset status.

In another embodiment, the server periodically evaluates the degree of achievement of the user's investment objective. The server computes the ratio between the current asset value and the goal value, compares it to predefined thresholds, and records these evaluations. The server then analyzes the relationship between the historical emotion state sequence and the historical asset value trajectory. Using the data analysis component, the server computes correlation metrics or co-occurrence statistics, such as how often high stress periods coincide with market drawdowns or high trading frequency. The server constructs a prompt sentence describing these relationships and instructs the generative AI model to generate a report summarizing past asset formation and proposing improvements. For example, the server may generate:
“Summarize the user's asset formation progress over the last 6 months and explain how emotion-based adjustments affected risk and returns. The user often experienced stress during volatile periods. Provide an easy-to-understand, encouraging report.”

The generative AI model returns a narrative report, and the server sends this to the terminal, where the user can review long-term patterns and recommendations.

In another embodiment, the server maintains a database of past investment performance data and market analysis data from public information sources. The server indexes these records by conditions such as risk tolerance level, investment horizon, and market regime. When given a user profile, the server searches the database for past successful cases with similar conditions and constructs a prompt sentence that asks the generative AI model to synthesize candidate asset management methods from those cases and to explain their evaluation. For example, the server generates:
“The user prefers medium risk and wants to double assets within five years. Considering historical cases of successful investors in similar conditions, propose several concrete investment methods and their risk-return characteristics.”

By delegating the synthesis and explanation tasks to the generative AI model while maintaining strict control over the input context via prompt sentences, the server enables a flexible advisory engine that can adapt to new data and models without rewriting large portions of the application code.

From a technical perspective, the described system improves computer technology in several ways. First, by unifying financial data, market data, and emotion data into a single feature representation and processing pipeline, the server reduces redundant data transformations and enables better cache locality and vectorized computation, thereby increasing processing speed and decreasing memory usage relative to conventional siloed designs. Second, by using the emotion state not merely as a display attribute but as a constraint in an optimization problem, the server changes the internal algorithmic behavior of the portfolio recommendation engine, leading to lower variance in user behavior and more stable portfolio trajectories, which can be quantified by reduced volatility in realized outcomes. Third, by programmatically generating prompt sentences from structured numerical and categorical data, the server creates a deterministic mapping from internal state to generative AI inputs, improving reproducibility and enabling automated, verifiable testing of natural language outputs. This is distinct from manual, ad-hoc use of language models and constitutes an improvement in how the computer orchestrates heterogeneous AI components.

Moreover, the combination of high-throughput numerical computation and generative language modeling under control of the server's state machine allows for efficient division of labor: heavy numeric forecasting is handled by specialized tensor engines, while explanatory reasoning is handled by the generative AI model. The server's control logic ensures that each component operates only on compact, necessary data, which reduces network load and latency. For example, instead of sending full transaction histories to the generative AI model, the server sends only summarized features and aggregated metrics encoded in prompt sentences, thereby reducing prompt length and inference time.

The system also introduces non-conventional processing flows compared with human-only workflows. A human advisor might reason qualitatively about a user's stress level and manually adjust a strategy, but the server encodes emotion-dependent adjustments in explicit mathematical functions and optimization constraints. A human advisor cannot in real time compute high-dimensional allocation adjustments under multiple constraints across many users, nor maintain a consistent mapping between internal quantitative models and user-facing text. The server's architecture specifically addresses these technical challenges by designing distinct modules for data ingestion, feature generation, numerical prediction, emotion estimation, strategy optimization, prompt generation, and generative explanation, connected by well-defined data structures and interfaces.

In alternative embodiments, the server can employ other neural network architectures, such as recurrent networks or attention-based encoders, to capture temporal dependencies in transaction sequences or emotion sequences. The emotion recognition model may incorporate multimodal fusion layers that jointly process image, audio, and biometric streams. The generative AI model may be hosted locally in a reduced form, such as a distilled language model, for deployment in environments with limited connectivity. The specific optimization method used for strategy adjustment may vary, including heuristic search or evolutionary algorithms, as long as the emotion state and user attributes are encoded as constraints or penalty terms in the objective function. In each case, the server maintains the core principle of constructing prompt sentences from internal, structured representations and using generative AI outputs as integrated components of a closed-loop computational pipeline. By implementing these embodiments, the system provides a concrete, technical solution that modifies the way a computer processes heterogeneous financial and emotion-related data, coordinates multiple AI models, and generates consistent, context-aware outputs. This results in improved accuracy of strategy recommendations, faster system responses, reduced network and storage overhead through structured data flows, and a more maintainable and testable architecture compared to conventional, purely rule-based or manually scripted advisory systems.

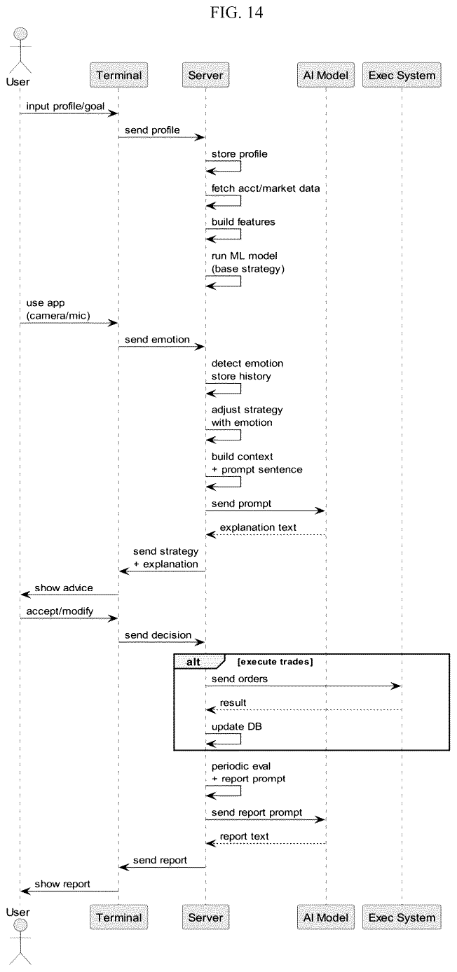

The following describes the processing flow using FIG. 14.

### Step 1:

User operates the terminal to input profile and goal information.
User enters age, investment horizon, risk tolerance, and target asset amounts through input forms on the terminal. The input is the set of profile fields (for example, age=40, horizon=5 years, risk tolerance=“medium,” target asset=2,000,000). The terminal validates format and completeness, converts the fields into a structured record (for example, a key-value map), and transmits this record to the server via a network request. The output of this step is a structured user profile message sent from the terminal to the server.

### Step 2:

Server receives and stores user profile and goal information.
Server accepts the profile message as input through an API endpoint, parses each field, and checks for logical consistency (for example, non-negative target amounts, reasonable age ranges). The server then executes database insert or update operations to write the profile into a user profile table. The data processing includes mapping text labels (for example, “medium” risk) to internal numeric codes and normalizing units (for example, converting years to months). The output of this step is a stored user profile record identified by a user identifier in the database.

### Step 3:

Server acquires financial account and transaction data.
Server uses the stored user identifier and associated authentication tokens as input to call external financial interfaces. The server sends authenticated requests to external systems and receives account balances, holdings, and transaction histories as response data. The server parses each record, converts currencies and timestamps into a standard internal format, and writes normalized rows into account, holdings, and transaction tables. The output of this step is a set of normalized financial records linked to the user in the database.

### Step 4:

Server acquires and records market data.
Server uses configuration data (for example, lists of symbols and indices) as input to request price series, indices, and volatility indicators from market data sources. The server receives time-stamped price records and computes derived fields such as moving averages and volatility estimates. The server then inserts or updates rows in a market data table, keyed by symbol and timestamp. The output of this step is a time-aligned market data store suitable for later joining with user transaction data.

### Step 5:

Server constructs feature vectors for the user.
Server uses, as input, the user profile, account and transaction records, and relevant market data over a defined time window. The server joins these tables by user identifier, asset identifier, and timestamp, and then computes portfolio metrics such as weight per asset class, historical return, realized volatility, maximum drawdown, diversification indices, and trading frequency. The server concatenates user-level features and market-level features into fixed-length numerical arrays. The data processing consists of aggregations, windowed statistics, and normalization (for example, z-score scaling). The output of this step is a user-specific feature matrix ready for input to a machine learning model.

### Step 6:

Server executes a numerical machine learning model for strategy prediction.
Server uses the feature matrix as input to a loaded neural network (for example, a multi-layer model) in inference mode. The server performs a forward pass, computing weighted sums and activation functions layer by layer, to generate outputs such as predicted asset growth curves, estimated portfolio volatility, and goal achievement probabilities. The server may also output a base allocation vector across asset classes as a recommendation. The output of this step is a numerical result object containing predictions and a base asset management strategy.

### Step 7:

Terminal captures emotion-related sensor data.
Terminal uses the camera, microphone, and optionally biometric sensors as input sources to capture facial images, voice recordings, and physiological measurements while the user interacts with the application. The terminal preprocesses these signals by detecting the face region, extracting image patches, computing audio features, and filtering biometric time series (for example, smoothing heart rate). The terminal then either generates emotion labels locally or compiles feature vectors for remote processing. The output of this step is either an emotion feature set or a set of labeled emotion states transmitted to the server.

### Step 8:

Server estimates user emotional state and records history.
Server uses sensor-derived features or reported emotion labels as input to an emotion recognition module. When using a neural network model, the server feeds the feature vectors into the model, which computes probabilities for categories such as stress, relaxation, joy, and sadness. The server selects the emotion with the highest probability and pairs it with a confidence score and timestamp. The server writes this record into an emotion state table associated with the user. The output of this step is an updated emotional state history stored in the database.

### Step 9:

Server adjusts the base asset management strategy according to emotional state.
Server uses, as input, the numerical result object from the strategy model, the latest segment of emotion state history, and the user profile. The server computes an emotion severity value (for example, high stress) and then applies a non-linear risk adjustment function to derive a target risk level. The server formulates an optimization problem where the variables are asset allocation ratios, the objective is to remain close to the base allocation, and the constraints enforce the target risk level and other policy rules. The server runs an optimization routine to solve this problem and obtains adjusted allocation ratios and updated risk indicators. The output of this step is an adjusted asset management strategy that reflects both model predictions and emotional constraints.

### Step 10:

Server composes a structured internal description of the adjusted strategy and context.
Server uses the adjusted strategy, user's current asset status, recent emotion state, and current market summary as input. The server aggregates these into an internal data object that includes allocation ratios, predicted performance, risk scores, key market indicators, and emotion labels. The server validates that all required fields are present and formats numerical values (for example, rounding, converting to percentages). The output of this step is a fully populated internal context object representing the current advisory state.

### Step 11:

Server generates a prompt sentence for the generative AI model.
Server uses the internal context object as input to a prompt construction module. The server replaces placeholders in predefined text templates with actual values from the context object, and assembles a multi-line prompt sentence that clearly specifies the user profile, current assets, model outputs, emotional state, and market environment. The data processing includes string formatting, ordering of sections, and insertion of explicit instructions (for example, “please propose a safer variant”). The output of this step is a complete prompt sentence ready to be sent to the generative AI model.

### Step 12:

Server calls the generative AI model and obtains an explanation text.
Server uses the prompt sentence as input to a generative AI endpoint via a network call. The server passes the prompt and configuration parameters such as maximum length and generation style. The remote model processes the prompt and returns a natural language response that includes detailed investment recommendations and rationale. The server receives this response and may segment it into sections or extract lists for easier display. The output of this step is an explanation text object containing the advisory narrative.

### Step 13:

Server prepares user-facing recommendation data.
Server uses the adjusted asset management strategy and the explanation text as input to a presentation preparation module. The server packages allocation ratios, predicted performance metrics, and key sentences from the explanation into a response payload. The server may also compute additional display data such as chart coordinates or progress percentages. The output of this step is a structured recommendation message suitable for consumption by the terminal.

### Step 14:

Terminal displays recommendations and explanations to the user.
Terminal receives the recommendation message as input from the server. The terminal renders graphical components such as pie charts, bar charts, and progress bars for the allocation and goal achievement, and displays the explanation text in readable paragraphs. The terminal may highlight how the emotional state influenced the strategy (for example, labels indicating “risk reduced due to stress”). The output of this step is a visual and textual representation of the recommendation on the terminal screen.

### Step 15:

User reviews and responds to the recommendation.
User views the displayed information as input and decides whether to accept, modify, or decline the strategy. The user may select buttons such as “Accept,” “Request safer strategy,” or “Ask for more details,” or type a follow-up question. The terminal converts the user's choice or question into a structured request message. The output of this step is a user response message transmitted back to the server.

### Step 16:

Server processes user response and optionally refines strategy or prompt.
Server uses the user response message as input, together with the current adjusted strategy and context object. If the user requests a safer or more aggressive variant, the server updates risk constraints and repeats the optimization and prompt-generation steps, producing a new adjusted strategy and a new prompt sentence. If the user asks a specific question, the server composes a follow-up prompt sentence incorporating that question (for example, “Please explain the risk of the recommended technology funds in more detail”) and calls the generative AI model again. The output of this step is either a refined strategy and explanation or an additional explanatory text.

### Step 17:

Server executes asset management transactions when authorized.
Server uses the user's explicit approval and the adjusted asset management strategy as input to a transaction execution module. The server computes order quantities for each asset based on current holdings and target allocation ratios, constructs transaction requests in the format required by an electronic settlement apparatus or transaction execution apparatus, and transmits those requests. The server receives execution confirmations or errors, and updates the account, holdings, and transaction tables accordingly. The output of this step is an updated financial state in the database reflecting executed trades.

### Step 18:

Server periodically evaluates goal achievement and generates reports.
Server uses historical asset values, transaction records, and emotion state history as input at scheduled times. The server calculates current progress toward goals, compares progress to thresholds, and computes statistics describing correlations between emotional states and portfolio performance. The server then builds a context object summarizing multi-month or multi-year performance and generates a prompt sentence instructing the generative AI model to create a human-readable report. The generative AI model returns a report text, which the server forwards to the terminal. The output of this step is a periodic advisory report presented to the user that reflects both financial outcomes and emotion-based adjustments.
The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.
Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.
For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.
The above exemplary embodiment gives an implementation example in which the specific processing is performed by the data processing device 12, however technology disclosed herein is not limited thereto, and the specific processing may be performed by the smart device 14.

### Second Exemplary Embodiment

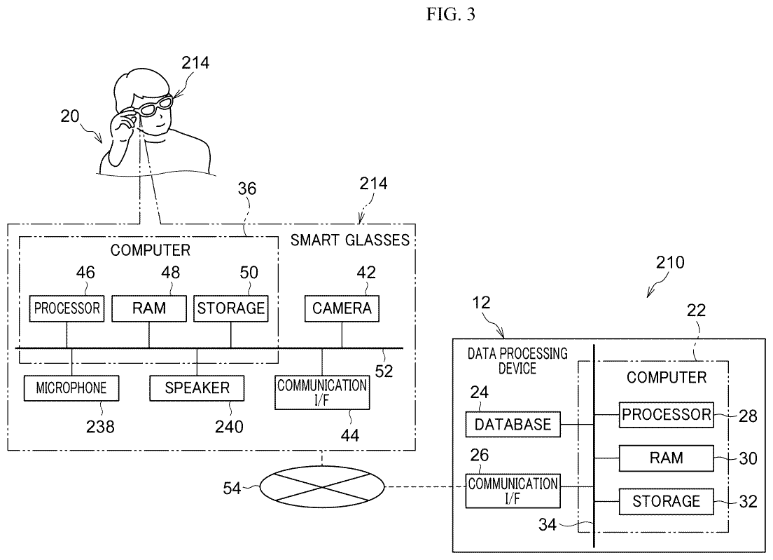

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

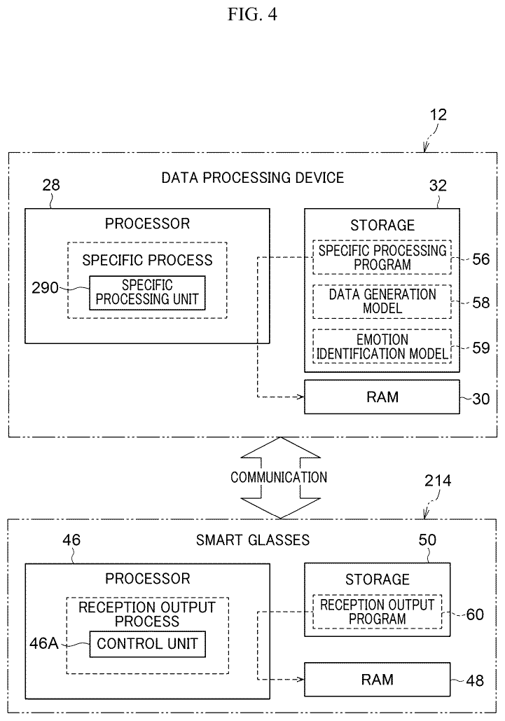

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

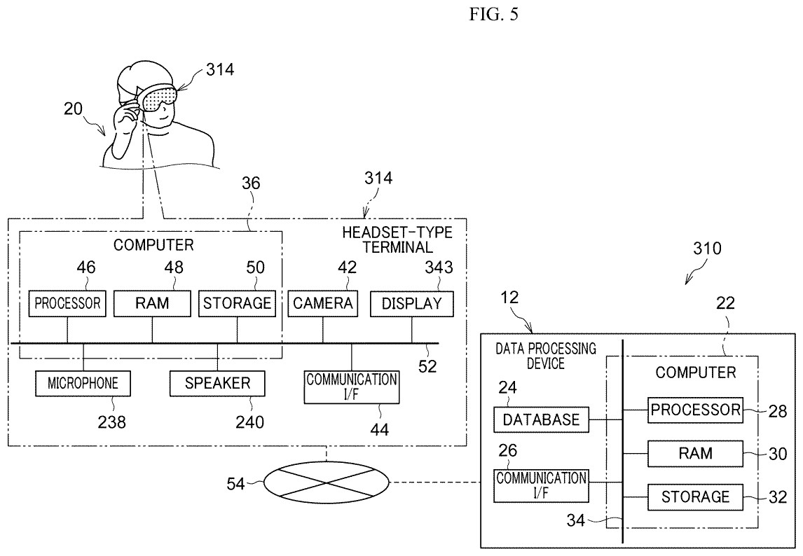

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

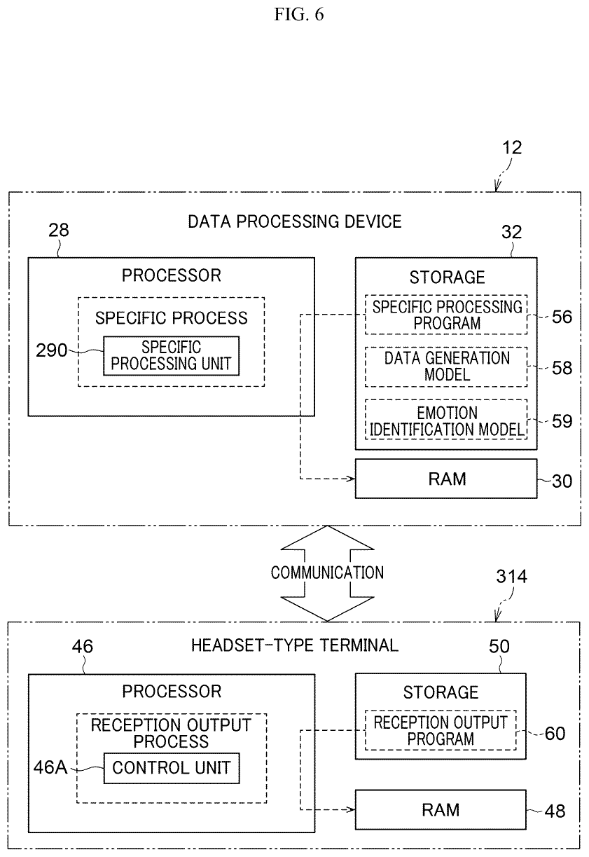

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

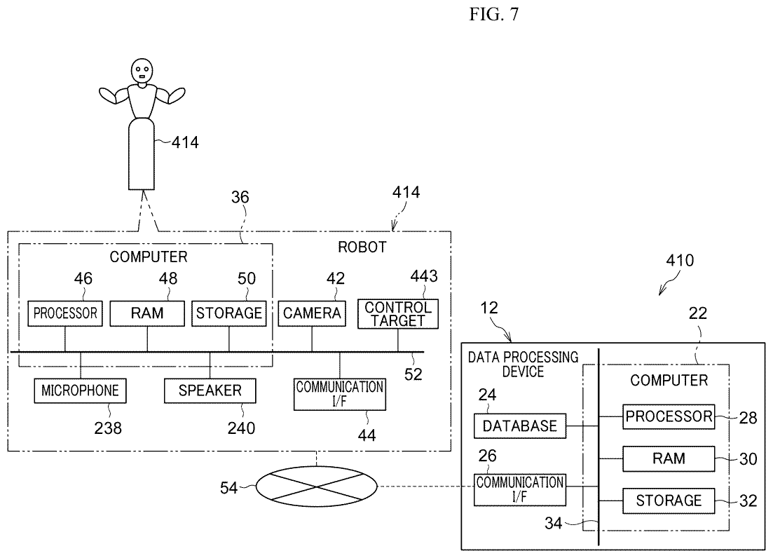

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

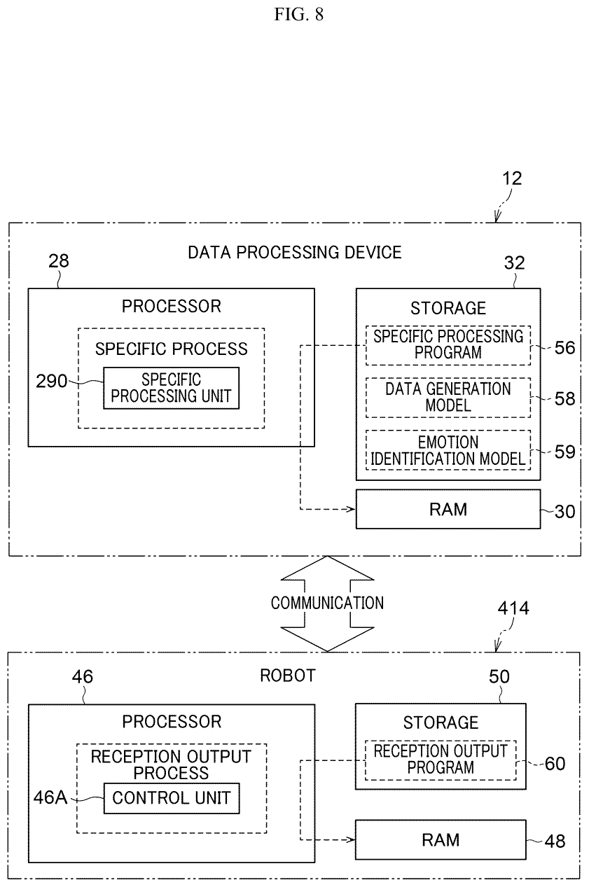

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

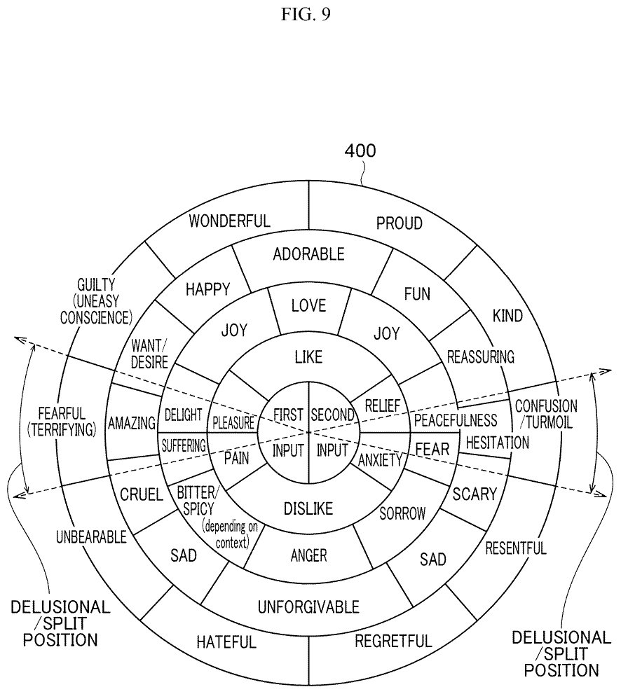

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

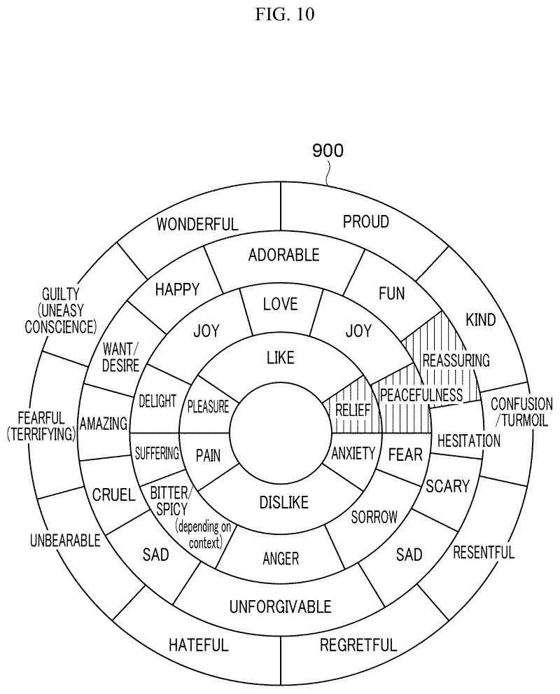

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire user attribute information and investment objective information from a user terminal, normalize the acquired information, and construct and store a structured user profile including at least an age category, an investment objective category, a numerical risk tolerance indicator, and a numerical investment period indicator,
calculate, based on the user profile and historical data including attribute information of a plurality of financial products and market data, for each of the financial products, a return indicator and a risk indicator by using a statistical analysis program or a machine learning program, and generate a suitability indicator associated with the user's risk tolerance and the investment period,
generate a prompt sentence by integrating (i) context information including the user profile, the plurality of financial products ranked according to the suitability indicator, and the return indicator and the risk indicator for each of the financial products, with (ii) a natural-language inquiry sentence acquired from the user, and input the prompt sentence to a generative AI model so as to cause the generative AI model to generate proposal content and an explanatory text indicating financial products suitable for the user,
format the proposal content and the explanatory text acquired from the generative AI model into output data including financial product list information and investment policy information, and transmit the output data to the user terminal for display, and
update, in response to an investment execution instruction based on the proposal content acquired from the user terminal, the user profile and the suitability indicator, and reflect the updated user profile and suitability indicator in generation of the prompt sentence and calculation of the suitability indicator in a subsequent processing.

### (Supplementary 2)

The system according to supplementary 1,
wherein the processor is configured to
handle, as the financial products, at least a tax-advantaged account, a contributory pension scheme, an installment-type investment scheme, and a minor-oriented investment scheme.

### (Supplementary 3)

The system according to supplementary 1,
wherein the processor is configured to
generate the prompt sentence by integrating structured context information including
quantitative indicators based on the user profile and the historical data with the natural-language inquiry sentence acquired from the user, and input the prompt sentence to the generative AI model so as to provide a customized proposal of investment means for each user.

### Application Example 1

### (Supplementary 1)

A system comprising a processor,
wherein the processor is configured to
generate, for comparing a plurality of asset management means and selecting at least one asset management means suitable for a user based on attribute information and financial information of the user, a prompt sentence for a generative artificial intelligence model, the prompt sentence including evaluation information comprising an output result of a machine learning model,
obtain, from a storage device, input information received from the user including an investable amount, an investment objective, an investment tolerance level, and an investment period, and historical information including transaction history information and expenditure history information, and process the historical information using a data analysis library to perform preprocessing and feature extraction so as to generate feature information representing an investment behavior tendency and an expenditure tendency of the user, execute, based on the feature information and the investment tolerance level, the machine learning model configured by using a machine learning library, to predict at least one of the plurality of asset management means as a recommended asset management means, generate, by using the recommended asset management means, the investable amount, the investment objective, and the investment tolerance level, a prompt sentence that defines a request content for explanation to the generative artificial intelligence model, and transmit the prompt sentence to an external generative artificial intelligence model so as to cause the external generative artificial intelligence model to generate an explanation text regarding the recommended asset management means,
generate output data including the recommended asset management means and the explanation text for output to a user display device, and transmit the output data to a user terminal device, and
record, in the storage device, a selection result of the recommended asset management means received from the user terminal device, and accumulate the selection result as learning data for future training of the machine learning model.

### (Supplementary 2)

The system according to supplementary 1,
wherein the processor is configured to
use, as the plurality of asset management means, at least a long-term installment-type asset management scheme having a tax-preferential structure and an investment scheme having a non-taxable limit for a contribution amount, and include, in the prompt sentence for the generative artificial intelligence model, information specifying at least one of the plurality of asset management means as the recommended asset management means and a request content for explanation of a utilization method corresponding to a monthly investable amount and the investment objective of the user.

### (Supplementary 3)

The system according to supplementary 1,
wherein the processor is configured to
generate, as the prompt sentence for the generative artificial intelligence model, a request content having a form of: “A user has a predetermined monthly investable amount, and an investment tolerance level at a predetermined level. The machine learning model recommends a specific asset management means as an optimal asset management method. Explain to the user, in an easy-to-understand manner, reasons for selecting the asset management means, advantages of the asset management means, and points to be noted.” and input the prompt sentence to the generative artificial intelligence model to obtain the explanation text.

### Example 2

### (Supplementary 1)

A system comprising a processor and a storage device,
wherein the processor is configured to
integrate investment transaction history information acquired from a user terminal and market-related information acquired from an external information providing apparatus, store the integrated information in the storage device, and generate investment behavior characteristic information and risk characteristic information based on the investment transaction history information and the market-related information,
generate a prompt sentence for instructing a generative AI model to generate investment strategy evaluation information including investment target information and investment allocation information, the prompt sentence being generated based on the investment behavior characteristic information, the risk characteristic information, and the market-related information,
execute the generative AI model by using the prompt sentence and the investment behavior characteristic information as input information, and acquire investment strategy candidate information output from the generative AI model,
store, in the storage device, a knowledge base including investment history information and investment policy information of past investment entities, and refer to the knowledge base to correct the investment strategy candidate information as investment knowledge referenced investment strategy information,
estimate user state information over time based on operation information from the user terminal and sensor information, and adjust a risk level and an asset allocation included in the investment strategy candidate information in accordance with the user state information as an emotion state estimation process, and
output, to the user terminal, investment strategy information obtained by the emotion state estimation process as an investment strategy presentation process.

### (Supplementary 2)

The system according to supplementary 1,
wherein the processor is configured to
acquire, as the investment transaction history information, system utilization transaction information of a plurality of types of investment systems including a contribution-type pension system, a tax-exempt investment system, an installment investment system, and a minor-oriented investment system, and reflect the system utilization transaction information of the plurality of types of investment systems in the investment behavior characteristic information.

### (Supplementary 3)

The system according to supplementary 1,
wherein the processor is configured to
acquire investment objective information and risk tolerance information of the user, generate constraint condition information by combining the investment objective information and the risk tolerance information with the investment transaction history information and the market-related information, and include the constraint condition information in the prompt sentence so as to control generation of the investment strategy candidate information by the generative AI model.

### Application Example 2

### (Supplementary 1)

A system comprising a processor,
wherein the processor is configured to
generate a prompt sentence that instructs a generative AI model to compare and recommend asset management methods based on user attribute information, investment objectives, and risk tolerance, and to obtain evaluation results of the asset management methods from a natural language output of the generative AI model;
preprocess, by using a database management component and a data analysis software component, account balance information, holding information, and transaction history information acquired from a financial information providing apparatus and a transaction information managing apparatus, together with market trend information acquired from a market information providing apparatus, to generate feature data, and input the feature data into a machine learning model to calculate future asset trends and goal achievement probabilities for each user;
estimate, in real time, an emotional state of a user by using an emotion recognition model based on facial expression information, voice information, or biometric information acquired from an image acquisition apparatus, a voice acquisition apparatus, or a biometric information acquisition apparatus, and record the estimation result as emotional state history; integrate numerical outputs of an asset management strategy from the machine learning model with the emotional state history and the user attribute information, and generate an adjusted management strategy in which asset allocation ratios, risk levels, and management policies are adjusted according to the emotional state;
generate a prompt sentence that instructs the generative AI model to explain, in natural language, contents of the adjusted management strategy and grounds for the adjusted management strategy, using explanation data including the adjusted management strategy, a current asset situation of the user, and summary information of a market environment, and obtain an explanation text from the generative AI model as proposal information for the user; and
perform display control and notification control on a user terminal based on the adjusted management strategy and the proposal information for the user, and, when necessary, instruct an electronic settlement apparatus or a transaction execution apparatus to execute an asset management transaction, and update the database management component with an execution result.

### (Supplementary 2)

The system according to supplementary 1,
wherein the processor is configured to
periodically evaluate an achievement degree of an asset management goal, analyze a relationship between past emotional states and asset transitions recorded in the database management component, generate a prompt sentence that instructs the generative AI model to generate, in a report format, a description of an asset formation situation over an elapsed period and an improvement plan of a management policy according to the emotional states, and provide the report to the user terminal.

### (Supplementary 3)

The system according to supplementary 1,
wherein the processor is configured to store, in a database, a plurality of investment performance data and market analysis data acquired from a public information source or an external information providing apparatus, generate a prompt sentence that instructs the generative AI model to present candidates of asset management methods and reasons for evaluation of the candidates based on past successful cases similar to the investment objectives and the risk tolerance of the user, and reflect a result generated by the generative AI model on generation of the adjusted management strategy.

What is claimed is:

1. A system comprising:
circuitry configured to:
receive, via a communication interface coupled to a packet-switched network, from a terminal device, attribute data and a natural-language query associated with a user;
generate, based on the attribute data and time-series external data received from an external information processing apparatus, a numerical feature vector representing characteristics of the user;
construct a natural-language prompt sentence incorporating the numerical feature vector and instructing a generative neural network model to evaluate a plurality of candidate items and produce a ranked recommendation;
execute the generative neural network model with the natural-language prompt sentence as an input to produce structured recommendation data; and
transmit, via the communication interface coupled to the packet-switched network, the structured recommendation data to the terminal device for presentation to the user.

2. The system according to claim 1, wherein the circuitry is further configured to: access a knowledge base stored in a storage device, the knowledge base comprising reference entity records encoding historical decision patterns and policy information; and refine the structured recommendation data by algorithmically referencing the knowledge base to produce knowledge-referenced recommendation data.

3. The system according to claim 2, wherein the circuitry is further configured to: compute a similarity measure between the numerical feature vector and feature vectors associated with the reference entity records; and select a subset of the reference entity records based on the similarity measure for use in refining the structured recommendation data.

4. The system according to claim 3, wherein: the reference entity records comprise investment history information and investment policy information of past investors; and the knowledge-referenced recommendation data comprises an investment strategy adjusted based on historically proven allocation patterns derived from the selected subset.

5. The system according to claim 4, wherein the circuitry is further configured to: retrieve, from the knowledge base, risk management constraint information associated with the selected subset; and apply the risk management constraint information to limit an allocation parameter in the knowledge-referenced recommendation data.

6. The system according to claim 1, wherein the circuitry is further configured to: receive, from the terminal device, operation information and sensor information associated with the user; and apply a state estimation function to the operation information and the sensor information to generate user state information representing a detected condition of the user.

7. The system according to claim 6, wherein the circuitry is further configured to: adjust a risk level parameter and an allocation parameter included in the structured recommendation data in accordance with the user state information.

8. The system according to claim 7, wherein: the user state information represents an emotional state of the user estimated from at least one of voice data, text input patterns, and interaction timing data captured by the terminal device; and the circuitry reduces the risk level parameter when the emotional state indicates elevated anxiety.

9. The system according to claim 8, wherein the circuitry is further configured to: apply a neural network model trained on labeled emotional state data to the voice data to generate an emotion classification label; and concatenate the emotion classification label with the numerical feature vector to produce an augmented feature vector used in constructing the natural-language prompt sentence.

10. The system according to claim 1, wherein the circuitry is further configured to: retrieve the time-series external data from the external information processing apparatus, the time-series external data comprising price information and index information associated with the plurality of candidate items; compute, from the time-series external data, return indicator values and risk indicator values for each of the plurality of candidate items; and incorporate the return indicator values and the risk indicator values into the natural-language prompt sentence.

11. The system according to claim 10, wherein the circuitry is further configured to: construct, for each of the plurality of candidate items, a feature vector encoding item attributes, the return indicator values, the risk indicator values, and user profile parameters derived from the attribute data; and apply a trained suitability model to each feature vector to generate a suitability score, the suitability scores being included in the natural-language prompt sentence.

12. The system according to claim 11, wherein: the plurality of candidate items comprise financial investment instruments; the item attributes comprise fee values, tax treatment flags, and eligibility constraints; and the circuitry filters the plurality of candidate items based on the suitability scores and the eligibility constraints before constructing the natural-language prompt sentence.

13. The system according to claim 1, wherein the circuitry is further configured to:
preprocess the attribute data by applying a tabular data processing function to generate structured feature information comprising an age category, a preference indicator, and a tolerance parameter; and apply a machine-learning feature transformation function to the structured feature information to produce the numerical feature vector.

14. The system according to claim 13, wherein the machine-learning feature transformation function comprises: encoding categorical variables using a one-hot encoding algorithm; scaling numerical variables using a standardization algorithm; and applying dimensionality reduction to produce a reduced-dimension numerical feature vector.

15. The system according to claim 14, wherein: the attribute data comprises an investment objective and a risk tolerance of the user; and the tolerance parameter represents the risk tolerance encoded as a numerical value used in the numerical feature vector.

16. The system according to claim 1, wherein the circuitry is further configured to: parse the structured recommendation data to extract a summary section, a detailed explanation section, and a ranked item list; and store the summary section and the detailed explanation section in an advice log associated with the user.

17. The system according to claim 16, wherein: the ranked item list identifies recommended investment instruments including at least one of a defined contribution pension plan, a tax-exempt investment scheme, and an installment-type investment scheme; the detailed explanation section comprises reasoning generated by the generative neural network model explaining the recommendation; and the circuitry receives, from the terminal device, an execution instruction selecting one or more items from the ranked item list and records a transaction in association with the user.

18. A system comprising:
circuitry configured to:
receive, via a communication interface coupled to a packet-switched network, from a terminal device, attribute data, a natural-language query, and sensor information associated with a user;
generate, based on the attribute data and time-series external data received from an external information processing apparatus, a numerical feature vector representing characteristics of the user;
apply a state estimation function to the sensor information to generate user state information;
construct a natural-language prompt sentence incorporating the numerical feature vector and the user state information, the natural-language prompt sentence instructing a generative neural network model to evaluate a plurality of candidate items and produce a ranked recommendation adjusted for a detected condition of the user;
execute the generative neural network model with the natural-language prompt sentence as an input to produce structured recommendation data; and
transmit, via the communication interface coupled to the packet-switched network, the structured recommendation data to the terminal device.

19. The system according to claim 18, wherein the circuitry is further configured to: access a knowledge base comprising reference entity records encoding historical decision patterns; and refine the structured recommendation data by computing a similarity measure between the numerical feature vector and feature vectors of the reference entity records and adjusting the structured recommendation data based on matched records.

20. A method performed by circuitry, the method comprising:
receiving, via a communication interface coupled to a packet-switched network, from a terminal device, attribute data and a natural-language query associated with a user;
generating, based on the attribute data and time-series external data received from an external information processing apparatus, a numerical feature vector representing characteristics of the user;
constructing a natural-language prompt sentence incorporating the numerical feature vector and instructing a generative neural network model to evaluate a plurality of candidate items and produce a ranked recommendation;
executing the generative neural network model with the natural-language prompt sentence as an input to produce structured recommendation data; and
transmitting, via the communication interface coupled to the packet-switched network, the structured recommendation data to the terminal device for presentation to the user.
